(19) United States
(12) Patent Application Publication
(10) Pub. No.: US 2013/0300186 A1
(43) Pub. Date: Nov. 14, 2013

(54) VEHICLE WHEEL SPOKE CONNECTION

(71) Applicant: Raphael Schlanger, Wilton, CT (US)

(72) Inventor: Raphael Schlanger, Wilton, CT (US)

(21) Appl. No.: 13/668,237

(22) Filed: Nov. 3, 2012

Related U.S. Application Data
(60) Provisional application No. 61/628,719, filed on Nov. 4, 2011.

(51) Int. Cl. B60B 1/04

(52) U.S. Cl. CPC B60B 1/043
USPC 301/58

(57) ABSTRACT

A vehicle wheel, comprising: a rim; a hub; a plurality of spokes; a bracing element including a hole, a hole sidewall, and an engagement surface outward of the hole; and a connecting element with a spoke opening and an overhang surface. The spoke is connected to the connecting element and the connecting element is connected to the bracing element at the hole, with the bracing element comprising one of the rim and hub. With the spoke maintaining alignment with the connector, the connecting element may be transitioned between an insertion orientation where the connecting element may be inserted in the hole and an engagement orientation where the connecting element is engaged to the bracing element, with a toggle angle between the insertion and engagement orientations. The hole is preferably a circular hole. The spoke opening preferably includes internal threads to mate with external threads of the spoke.

### CROSS-REFERENCE TO RELATED APPLICATION

This application claims priority of U.S. provisional patent application No. 61/628,719, filed Nov. 4, 2011, and entitled “VEHICLE WHEEL SPOKE CONNECTION”

### BACKGROUND OF THE INVENTION

(1) Field of the Invention

This invention is related to the means of attachment between the spoke and the rim of a vehicle wheel and between the spoke and hub of a vehicle wheel. This invention is particularly related to the connection of a spoke with a rim structure having a “double-wall” construction.

(2) Description of the Related Art

Bicycle wheel rims have historically been constructed to accept pneumatic tires that are designed to work in conjunction with an inner tube. This is the standard of the industry and is the arrangement that we are all familiar with. In this prior art configuration, the rim's tire bed includes a through-hole that is drilled through for passage of the spoke nipple. In a rim of “single-wall” construction, the spoke nipple bears directly against the rim's tire bed. In a rim of “double-wall” rim construction, the rim has two lateral walls, a tire bed and a spoke bed, with a cavity in between. The rim is drilled through both walls, piercing both the tire bed and the spoke bed, with the spoke bed recessed below the tire bed to accept the spoke nipples. Generally, the spoke is presented through the spoke bed from the inside diameter of the rim and the spoke nipple is presented for attachment to the spoke through the tire bed and from the outside diameter of the rim. With single-wall or double-wall rim constructions, a rim strip is utilized to protect the inner tube from the sharp edges associated with the holes and/or the spoke nipples. With rims of double-wall construction, the rim strip also serves to prevent the inner tube from extruding through the drilled access openings in the tire bed.

With the recent advent of tubeless tire technology for bicycles, where the conventional inner tube is eliminated and the tire's beads are sealed directly against the rim, it is desirable that the tire well be sealed and airtight to prevent air leakage from the tire cavity. This typically involves a rim of double-wall construction where the tire bed wall is sealed while the spoke bed wall is then adapted to accept the spokes. One method for sealing the tire bed is to eliminate the aforementioned spoke access holes in the tire bed. If the tire bed is not pierced for the spokes, then the only hole through the tire bed will be for the tire inflation valve, which may be constructed of rubber and is relatively easy to seal against the tire bed. An example of such a tubeless arrangement is outlined by Lacombe et al. in U.S. Pat. No. 6,443,533, where the tire bed remains unpierced and the spoke bed includes extruded spoke holes that are directly threaded with internal threads to accept special externally threaded spoke nipples.

While the vast majority of prior art designs do not permit a blind connection between the spoke and the spoke bed, there have been some prior art designs that have attempted to incorporate such a blind connection. One such example is Altenburger (U.S. Pat. No. 2,937,905). Altenburger's FIGS. 6-10, which shows a pressed sheetmetal anchor element (32) which may be considered analogous to the connector of the present invention. However, Altenburger's design is very different from the present invention and has many shortcomings. It is firstly noted that Altenburger requires a noncircular hole in his inner bottom (13), which may be considered analogous to a spoke bed. This noncircular hole is very complex and expensive to produce. While a circular hole may easily be produced by simple drilling, such a noncircular hole must be produced by milling this complex profile. This adds considerable labor, time and expense to the production of Altenburger's rim. It is further noted that Altenburger's noncircular hole is much larger than his spoke nipple. This large hole serves to remove considerable material from his inner bottom, which significantly weakens his rim. Still further, Altenburger's noncircular hole is shown to have sharp corners, which creates a stress concentration to further weaken his rim. Yet further, Altenburger's anchor element is very large, resulting in a connector of substantial weight, which adds considerable weight to the wheel assembly. Further still, Altenburger's elongated hole and anchor element are shown to require a rather small shallow toggle angle of for insertion. Since the spokes of a tension-spoke wheel may sometimes become de-tensioned during an impact to the rim, this increases the probability that the anchor element may be dislodged or disconnected from the rim during such an impact. Still further, Altenburger's anchor element includes an unthreaded bore (35) to accept his spoke and does not include an internally threaded hole or an externally threaded stud to provide a direct threaded connection to engage his spoke. Instead, Altenburger relies on an overlie connection between his anchor element and his nipple, which does not provide a means to adjust the tension of his spoke. Thus, he must rely on a separate threaded connection to provide such adjustment means. Additionally, unlike a threaded connection, his overlie connection requires that his nipple must be preassembled to his anchor element prior to insertion and may not be assembled to his anchor element after insertion. However, such a post-insertion engagement would be possible with a threaded connection.

Another such example is Meggiolan (U.S. Pat. No. 7,748,790). Meggiolan shows a plate (50) which may be considered analogous to the connector of the present invention. However, Meggiolan's design is very different from the present invention and has many shortcomings. His design is based on his plate (50) being articulated to toggle relative to his spoke and spoke nipple. This requires that his inner hole (51) (analogous to the spoke opening of the present invention) be much larger than shank (41) of his nipple (40) in order to accommodate clearance required to achieve this toggling action. Firstly, since more material is removed for the larger inner hole, his plate is weakened. Or else, the plate must be made correspondingly larger, requiring a larger hole in his rim, thereby also weakening his rim. Further, his large inner hole correspondingly reduces the surface area of overlie engagement with his conical surface (44) (analogous to the transition surface of the present invention). This reduced surface area results in greater contact stress at this interface and greater propensity for galling and deformation. Further, since his plate is designed to pivot and toggle relative to his spoke, his spoke obviously does not maintain alignment with his plate. A such, the spoke cannot be used as a handle to manipulate and guide his plate for insertion through the hole in his rim or to align his plate after insertion. Therefore, controlled insertion of his plate is a very difficult and tedious process. It is also difficult to control alignment of his plate after insertion. Still further, Meggiolan's plate does not include an internally threaded spoke hole or an externally threaded stud for a direct threaded connection to engage the spoke. Instead, Meggiolan relies on an overlie connection between his plate and his nipple, which does not provide a means to adjust the tension of his spoke. Thus, he must rely on a separate threaded connection to provide such means. Additionally, unlike a threaded connection, his overlie connection must be preassembled to his inner hole (51) prior to insertion and may not be assembled to his plate after insertion. Additionally, unlike a threaded connection, his overlie connection requires that his nipple must be preassembled to his plate prior to insertion and may not be assembled to his anchor element after insertion However, such a post-insertion engagement would be possible with a threaded connection.

### SUMMARY OF THE INVENTION

The present invention utilizes a connecting element or ferrule that is blindly inserted through a hole in the spoke bed in an outwardly direction. The connecting element is first aligned in a skewed insertion orientation such that it may be inserted blindly though a hole in the spoke bed. Then the connecting element is pivoted relative to the spoke bed such that the spoke is aligned with the tensile axis in an engagement orientation such that the connecting element now has an overlie engagement with the spoke bed and can support spoke tension loads. The spoke, or an intermediate element connected to the spoke, is also engaged to the connecting element to create a firm connection between the spoke and the connector. Thus, the spoke is connected to the connector and the connector is connected to the spoke bed to create a firm structural connection between the spoke and the spoke bed to support spoke tension loads. This arrangement permits the spoke to be connected to the spoke bed via access to only one side of the spoke bed in a blind connection. It is noted that the spoke bed constitutes a portion of the rim or hub flange to which the connecting element is attached. As the novelty of a blind connection of the spoke is particularly advantageous in conjunction with rims associated with tubeless tires, most of the embodiments herein are shown with a spoke bed associated with a rim.

One aspect of the invention involves a method for assembling a wheel. For each of a number of spoke holes in the wheel rim, a connecting element associated with a given spoke is first aligned in an insertion orientation relative to the spoke bed. Next, the connecting element is inserted generally radially outward through the spoke hole in the spoke bed (or radially inwardly for a spoke bed associated with a hub). Then, the connecting element is swiveled or toggled relative to the spoke to an engagement orientation such that the connecting element may engage the edge or surface adjacent the distal end of the spoke hole. The connector may inserted to pass through the hole while in the insertion orientation, but may not be withdrawn through the hole while in the engagement orientation. A spoke is connected to the connecting element, either directly or by means of an intermediate connecting element. This connection between spoke and connecting element preferably includes an overlie engagement, a threaded engagement, or an adhesively bonded joinder.

In various implementations, the connecting element may be designed to tilt, swing or toggle through a variety of toggle angles between the insertion orientation and the engagement orientation, the connecting element may be keyed to the hole, the connecting element may be keyed to the spoke bed surface, the connector may include a piloting collar that extends within the spoke hole and engages the hole sidewall, the connecting element may include an elongated opening to receive the spoke and allow the spoke to toggle relative to the spoke, the spoke hole may be circular or it may be noncircular to receive the connecting element.

Another aspect of the invention involves a wheel. The wheel has a rim with a spoke bed having spoke holes and may have a tire bed radially outboard of the spoke bed and lacking holes aligned with the spoke holes. The rim may include a pair of lateral walls extending radially outward from opposite sides of the tire bed to cooperate with the tire bed to bound a tire well for receiving a tire. Spokes couple the rim to the hub. The connecting element is used to connect a spoke to the rim or to the hub. The connecting element has an insertion orientation relative to the spoke bed. The connecting element, while in the insertion orientation, is inserted through the spoke hole such that an overhang surface of the connecting element extends past a distal edge of the spoke hole. The connecting element is then tilted and realigned relative to the spoke bed such that an overhang surface of the connecting element now overlies the distal edge of the spoke hole in an engagement orientation. The connecting element includes an opening to receive the spoke.

A opening of the connector accommodates either an associated spoke or an intermediate element coupled to the associated spoke. The overhang surface is longitudinally outward of the spoke bed and cooperating with a longitudinally outward surface of the spoke bed to prevent the longitudinally inward movement of the connector and associated spoke and permitting tension in the spoke to be transferred to the spoke bed. In various implementations, the connector may consist essentially of a single piece. The spoke, or an intermediate element coupled to the spoke, may have an overlie engagement with the connector. The assembly of the spoke and the connector may also include a portion that engages the spoke bed to limit movement of the connector in the longitudinally outward direction.

Another aspect of the invention involves a wheel rim. The rim has a spoke bed with a number of spoke holes, commonly produced by drilling. It is preferred that the hole in the spoke bed is circular, as this may be produced by drilling, rather than more expensive operations, such as milling. A tire bed is radially outboard of the spoke bed and may lack access holes aligned with the spoke holes. Lateral walls extend radially outward from opposite sides of the tire bed and cooperate with the tire bed to form a tire well. The rim may be substantially unitarily formed from a light alloy (e.g., aluminum alloy) or a fiber composite. A clincher tire may be mounted in the tire well advantageously in the absence of a separate tube. A valve may be sealingly mounted in a valve hole in the tire bed and extending through a valve hole in the spoke bed for inflating the tire.

It is an object of the invention to provide a spoke connection that may provide a blind connection between the spoke and the spoke bed preferably to permit the tire bed wall of the rim to remain unpierced and preferably to permit the tire bed wall to be a sealed air barrier in a tubeless tire application. It may be seen that such a blind connection is indeed achieved by the present invention. It is a further object of the invention to provide a spoke connection that is simple and easy to install in the rim or hub. It may be seen that the connector may be easily inserted and engaged to the spoke bed, preferably where the spoke maintains its alignment with the connector such that the spoke may serve as a handle to guide and control the connector as it is inserted. It is a still further object of the invention to provide a spoke connection where the spoke hole of the connector and the hole of the spoke bed are as small as possible to minimize material removal and to correspondingly increase the strength of the connector and the rim. In contrast to Meggiolan (U.S. Pat. No. 7,748,790), the connector is not required to articulate or toggle relative to the spoke. This reduces the clearance required between the spoke and the spoke hole of the connector and reduces the size of the spoke hole for a corresponding increase in connector strength. In contrast to Altenburger, the toggle angle of the present invention is much greater, which permits the hole in the spoke bed to be much smaller for a corresponding increase in spoke bed strength. It is a yet further object of the invention to provide a spoke connection that is light in weight. In contrast to Altenburger, the connector of the present invention may be much smaller, which saves precious weight of the connector as well as the entire wheel assembly. It is a further still object of the present invention to provide a spoke connection that may employ a circular hole in the spoke bed. A circular hole is much easier and faster to produce than a noncircular hole (as shown by Altenburger). The circular hole of the present invention may be produced by common drilling methods, which are fast, precise and economical to produce. It is a further object of the invention to produce a spoke connection that may not be easily dislodged in the case where the spoke becomes de-tensioned in use, particularly during an impact to the wheel, etc. In contrast to Altenburger, which gas a relatively small toggle angle, the large toggle angle of the present invention insures that the spoke will not be become disengaged from the spoke bed due to de-tensioning or bending of the spoke.

### BRIEF DESCRIPTION OF THE DRAWINGS

The present invention will be more readily understandable from a consideration of the accompanying drawings, wherein:

FIG. 1 is a perspective view schematically illustrating the general configuration of a prior art vehicle wheel as applied to a bicycle wheel;

FIG. 2a is an axial plan view illustrating a prior art bicycle wheel;

FIG. 2b is a cross-section view of the prior art bicycle wheel of FIG. 2a, as seen generally in the direction 15-15;

FIG. 2c is a fragmentary view detailing the view illustrated in FIG. 2b where the hub flange is shown in a partial cross-section to illustrate the connection with the spoke;

FIG. 3a is a partial radial cross-sectional view of a prior art single-wall rim;

FIG. 3b is a partial radial cross-sectional view of a prior art double-wall rim;

FIG. 4a is an orthogonal top view of a connector of a first embodiment of the present invention;

FIG. 4b is an orthogonal side view, taken along 130-130, of the connector of FIG. 4a;

FIG. 4c is an orthogonal bottom view, taken along 131-131, of the connector of FIG. 4b;

FIG. 4d is a perspective view of the connector of the embodiment of FIGS. 4a-c;

FIG. 4e is a cross section view, as taken along 129-129, of the connector of the embodiment of FIGS. 4a-c;

FIGS. 4f-j are partial perspective views of the embodiment of FIGS. 4a-c, including a connector, a spoke and a spoke bed, illustrating progressive assembly sequences as the spoke and connector are blindly assembled to the spoke bed;

FIGS. 4k-p are cross section views, taken along 132-132 of the embodiment of FIGS. 4a-c, including a spoke and a spoke bed, illustrating progressive assembly sequences as the spoke and connector are blindly assembled to the spoke bed;

FIG. 4k corresponds to the assembly sequence of FIG. 4f;

FIG. 4L corresponds to the assembly sequence of FIG. 4g;

FIG. 4m corresponds to the assembly sequence of FIG. 4h;

FIG. 4n corresponds to a transitional assembly sequence between FIG. 4h and FIG. 4i;

FIG. 4o corresponds to the assembly sequence of FIG. 4i;

FIG. 4p corresponds to the assembly sequence of FIG. 4j;

FIG. 4q is a cross section view, as taken along 129-129 of a connector of the embodiment of FIGS. 4a-c, shown alternatively with the opening axis at a non-orthogonal angle relative to the engagement axis;

FIGS. 5a-b are perspective views of a connector of a second embodiment of the present invention;

FIG. 5c is an orthogonal view, taken along 204-204 of the connector of the embodiment of FIGS. 5a-b

FIGS. 5d-h are partial perspective views of the embodiment of FIGS. 5a-b, including a spoke, a spoke nipple, a connector and a spoke bed, and illustrating progressive assembly sequences as the spoke and connector are blindly assembled to the outer rim;

FIG. 5i-n are partial cross section views, taken along 199-199 of the embodiment of FIGS. 5a-b, illustrating progressive assembly sequences as the spoke and connector are blindly assembled to the spoke bed;

FIG. 5i corresponds to the assembly sequence of FIG. 5d;

FIG. 5j corresponds to the assembly sequence of FIG. 5e;

FIG. 5k corresponds to the assembly sequence of FIG. 5f;

FIG. 5L corresponds to a transitional assembly sequence between FIG. 5f and FIG. 5g;

FIG. 5m corresponds to the assembly sequence of FIG. 5g;

FIG. 5n corresponds to the assembly sequence of FIG. 5h;

FIG. 6a is a perspective view of a connector of a third embodiment of the present invention, including a collar portion and internal threads;

FIG. 6b is a cross section view, as taken along 235-235 of the connector of the embodiment of FIG. 6a;

FIG. 6c is an orthogonal view, as taken along 236-236 of the connector of the embodiment of FIG. 6a;

FIGS. 6d-g are partial perspective views of the embodiment of FIG. 6a, including a spoke and a spoke bed, illustrating progressive assembly sequences as the spoke and connector are blindly assembled to the spoke bed, including a threaded engagement between the spoke and the connector;

FIGS. 6h-k are cross section views, taken along 237-237 of the embodiment of FIGS. 6d-g including a spoke and a spoke bed, illustrating progressive assembly sequences as the spoke and connector are blindly assembled to the spoke bed;

FIG. 6h corresponds to the assembly sequence of FIG. 6e;

FIG. 6i corresponds to a transitional assembly sequence between FIG. 6e and FIG. 6f;

FIG. 6j corresponds to the assembly sequence of FIG. 6f;

FIG. 6k corresponds to the assembly sequence of FIG. 6g;

FIG. 6L is a cross section view, as taken along 235-235 of a connector of the embodiment of FIG. 6a, shown alternatively with an externally threaded stud, and including an internally threaded spoke;

FIGS. 7a-b are perspective views of a connector of a fourth embodiment of the present invention, including an internally threaded hole;

FIG. 7c-d and FIG. 7f are orthogonal views of the connector of the embodiment of FIGS. 7a-b;

FIG. 7e is a cross section view, as taken along 285-285 of the connector of the embodiment of FIGS. 7a-b;

FIG. 7g is a partial perspective exploded view of the embodiment of FIGS. 7a-b, including a spoke, a sleeve, a connector and a rim;

FIG. 7h is a partial perspective view of the embodiment of FIG. 7g, showing the connector engaged to the rim and the sleeve and spoke engaged to the connector;

FIGS. 7i-m are cross section views, taken along 286-286 of the embodiment of FIG. 7g, including a spoke a sleeve, a connector and a rim, illustrating a progressive assembly sequence as the spoke and connector are blindly assembled to the spoke bed;

FIG. 7n is a cross section view, taken along 287-287, of the embodiment of FIG. 7m, showing the connector engaged to the rim and the sleeve and spoke engaged to the connector;

FIG. 7o is a cross section exploded view, as taken along 286-286 of a connector similar to the embodiment of FIG. 7a-b, shown alternatively without a collar, and instead including an internally threaded collar, also including a spoke, a sleeve and a rim;

FIG. 7p is a cross section view, as taken along 286-286 of a connector of the embodiment of FIG. 7o, showing the connector engaged to the rim and the sleeve and spoke engaged to the connector and the collar engaged to the sleeve.

### DETAILED DESCRIPTION OF THE INVENTION

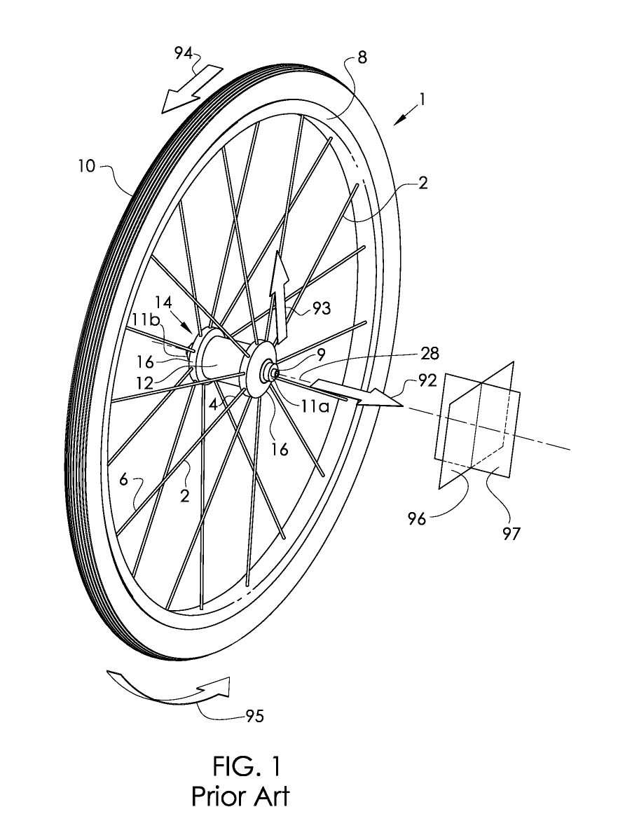

FIG. 1 describes the basic configuration of an exemplary prior art vehicle wheel, in particular, a bicycle wheel 1, as well as a description of the direction conventions used throughout this disclosure. For clarity, the frame and the quick release skewer assembly are not shown in this figure. The hub shell 14 is rotatable about the axle 9 and includes at least two axially spaced hub flanges 16, each of which include a means for connecting with the spokes 2. Axle 9 includes end faces 11a and 11b that define the spacing of its mounting with the frame (not shown). The axial axis 28 is the axial centerline of rotation of the bicycle wheel 1. The hub flange 16 may be contiguous with the hub shell 14 or it may be separately formed and assembled to the hub body 12 portion of the hub shell 14. The spokes 2 are affixed to the hub flange 16 at their first end 4 and extend to attach the rim 8 at their second end 6. The tire 10 is fitted to the outer periphery of the rim 8. The wheel of FIG. 1 is generic and may be of tension-spoke or compression-spoke design.

The axial direction 92 is any direction parallel with the axial axis 28. The radial direction 93 is a direction generally perpendicular to the axial direction 92 and extending generally from the axial axis 28 radially outwardly toward the rim 8. The tangential direction 94 is a direction generally tangent to the rim at a given radius. The circumferential direction 95 is a cylindrical vector that wraps around the axial axis 28 at a given radius. A radial plane 96 is a plane perpendicular to the axial axis 28 that extends in a generally radial direction at a given axial intercept. An axial plane 97 is a plane that is generally parallel to the axial axis. An axially inboard orientation is an orientation that is axially proximal to the axial midpoint between the two end faces 11a and 11b. Conversely, an axially outboard orientation is an orientation that is axially distal to the axial midpoint between the two end faces 11a and 11b. An axially inwardly facing surface is a surface that faces toward the axial midpoint between the two end faces 11a and 11b. Conversely, an axially outwardly facing surface is a surface that faces away from the axial midpoint between the two end faces 11a and 11b. Similarly, an axially inward direction is a direction that extends toward the axial midpoint between the two end faces 11a and 11b. Conversely, an axially outward direction is a direction that extends away from the axial midpoint between the two end faces 11a and 11b. A radially inboard orientation is an orientation that is radially proximal to the axial axis 28 and a radially outboard orientation is an orientation that is radially distal to the axial axis 28.

While it is most common for the hub shell 14 to rotate about a fixed axle 9, there are some cases where it is desirable to permit the axle 9 to be fixed with the wheel 1, such as the case where the wheel 1 is driven by the axle 9.

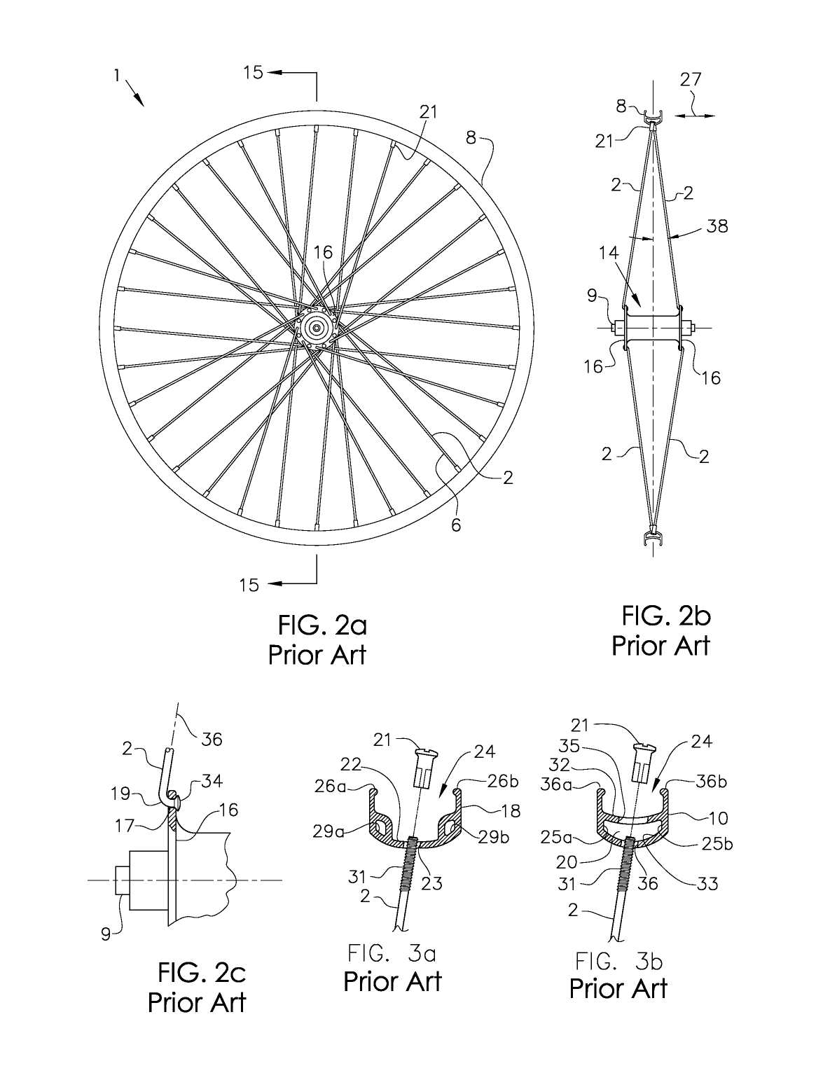

FIGS. 2a, 2b and 2c describe the current technology in conventional bicycle wheels that most cyclists are familiar with. This prior art design includes a rim 8, a hub shell 14 and a plurality of spokes 2. The hub shell 14 is rotatable about the axle 9 and includes a pair of axially spaced hub flanges 16. The wheel is assembled by first threading each individual spoke 2 through an axial hole 17 in the hub flange 16 until the j-bend 19 is hooked within the hole 17. The spoke 2 is then pivoted to extend in a generally radial direction toward the rim 8. The enlarged portion 34 or “head” of the spoke 2 prevents the spoke 2 from pulling through the hole 17 in the hub flange 16. The second end 6 of each spoke 2 is then fixed to the rim 8 via spoke nipples 21. Tightening the threaded engagement between the spoke nipple 21 and the spoke 2 serves to effectively shorten the length of the spoke 2. Thus, as the nipples 21 are threadably tightened, the spokes are drawn up tight and a degree of pre-tension is induced in the spoke 2. By selectively adjusting this threaded engagement, the spoke pre-tension may be adjusted to align the trueness of the rim 8. The spoke pre-tension is resisted by circumferential compression of the rim 8 and it is this balance of forces that imparts efficient structural integrity to the bicycle wheel 1. Also shown in FIG. 2b is bracing angle 38 between the radial centerline plane of the rim 8 and the tensile axis 36 of the spokes 2. As this bracing angle 38 is increased, the lateral stiffness (i.e. stiffness in the axial direction 92) of the wheel 1 is also increased.

FIG. 3a shows prior art single-wall rim 18 with a single lower web or spoke bed 22 wall. Rim 18 includes two hooked flanges 26a and 26b for capturing the bead of a tire (not shown). Tire well 24 is a circumferential channel bounded by spoke bed 22 and flanges 26a and 26b. Spoke 2 includes threaded end 31 for threadable engagement with spoke nipple 21. Rim 18 may be produced as an aluminum extrusion that also includes cavities 29a and 29b to accept pins (not shown) that serve to join the butted ends of the extruded profile to create a continuous rim hoop. During assembly, the threaded end 31 of spoke 2 is first positioned to extend through the inside diameter end of opening 23. Next, the nipple 21 may be threadably assembled to the threaded end 31 of the spoke 2 through the outside diameter end of opening 23. With all of the spokes 2 of the wheel assembled to the rim 18 in this way, a completed wheel assembly 1 is achieved. A rim strip (not shown) is commonly utilized to cover the radial outboard surface of the spoke bed and to protect the inner tube (not shown) from damage.

FIG. 3b shows a prior art rim 20 of double-wall configuration with an upper web or tire bed 32 wall and a lower web or spoke bed 33 wall. Rim 10 includes two hooked flanges 36a and 36b for capturing the bead of a tire (not shown). Tire well 24 is a circumferential channel bounded by tire bed 32 and flanges 36a and 36b. Spoke bed 33 includes opening 36 and tire bed 32 includes concentric opening 35, which serve to accept a spoke 2 and spoke nipple 21. Spoke 2 includes threaded end 31 for threadable engagement with spoke nipple 21. Rim 18 is produced as an aluminum extrusion that also includes an internal cavity 20 bounded by the spoke bed 33, the tire bed 32 and sides 25. It may be seen that, during assembly, the threaded end 31 of spoke 2 is first positioned to extend through the inside diameter end of opening 35. Next, the nipple 21 is threadably assembled to the threaded end 31 of the spoke 2 first through opening 35 and then through opening 36. With all of the spokes 2 of the wheel assembled to the rim in this manner, a completed wheel assembly is achieved. It may be seen that, with the nipple 21 bearing against the spoke bed 32, opening 35 remains exposed as a passageway between the tire well 24 and the cavity 20. A rim strip (not shown) is commonly utilized to cover the radial outboard surface of the spoke bed and to protect the inner tube (not shown) from damage.

The present invention comprises a spoke, which may be considered as a longitudinal tensile element having an end portion and a cross-section thereof, a connecting element (i.e. connector), a bracing element, and a tensile axis of applied tensile load along the longitudinal tensile element. The spoke is connected to the connecting element by means of an overlie connection between the spoke, or between an intermediate element connected to the spoke, and the connecting element. In the embodiments shown herein, the longitudinal tensile element is a vehicle wheel spoke, the hub shell or hub flange constitutes a first bracing element and the outer rim constitutes a second bracing element.

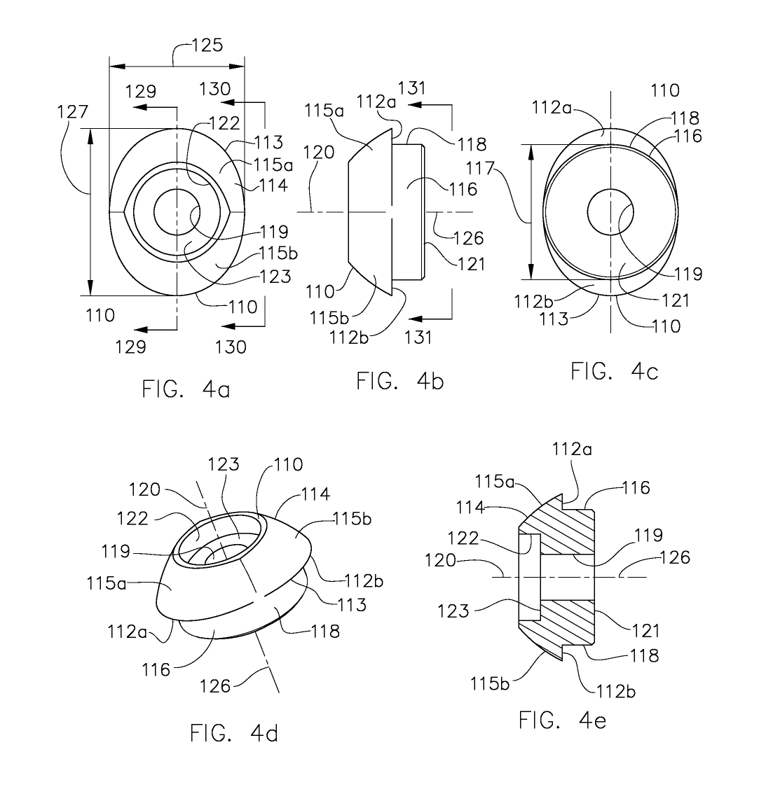

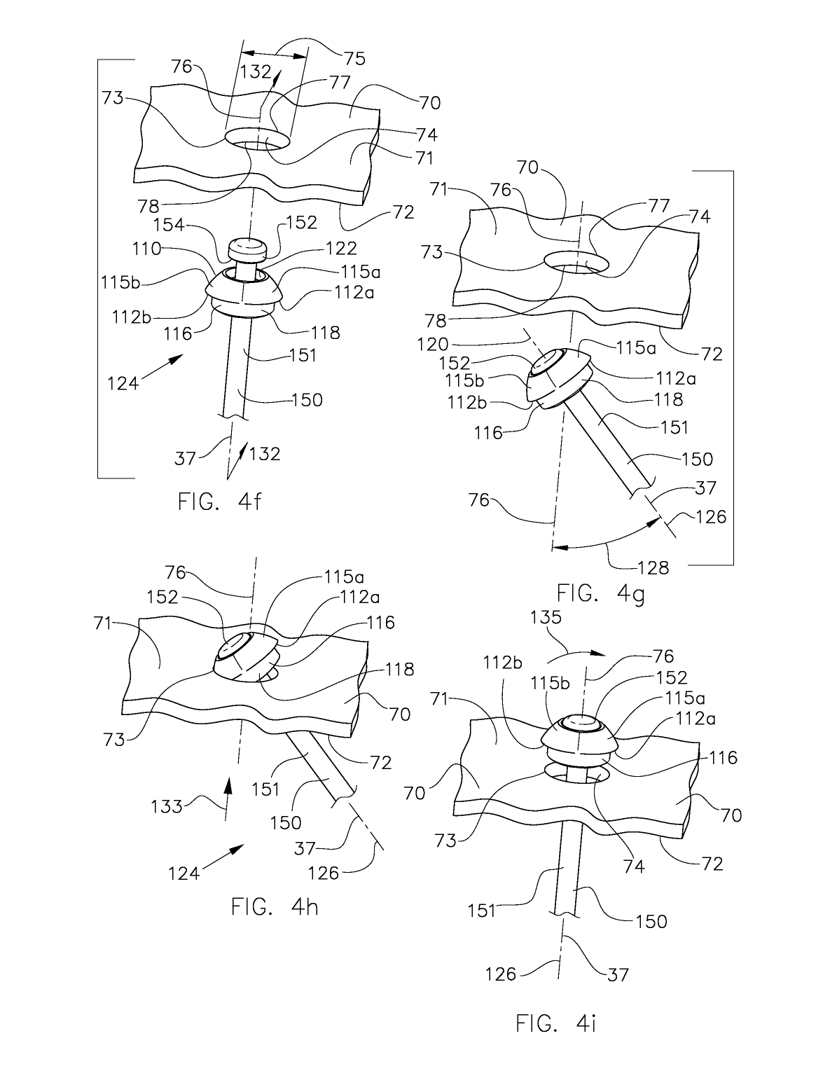

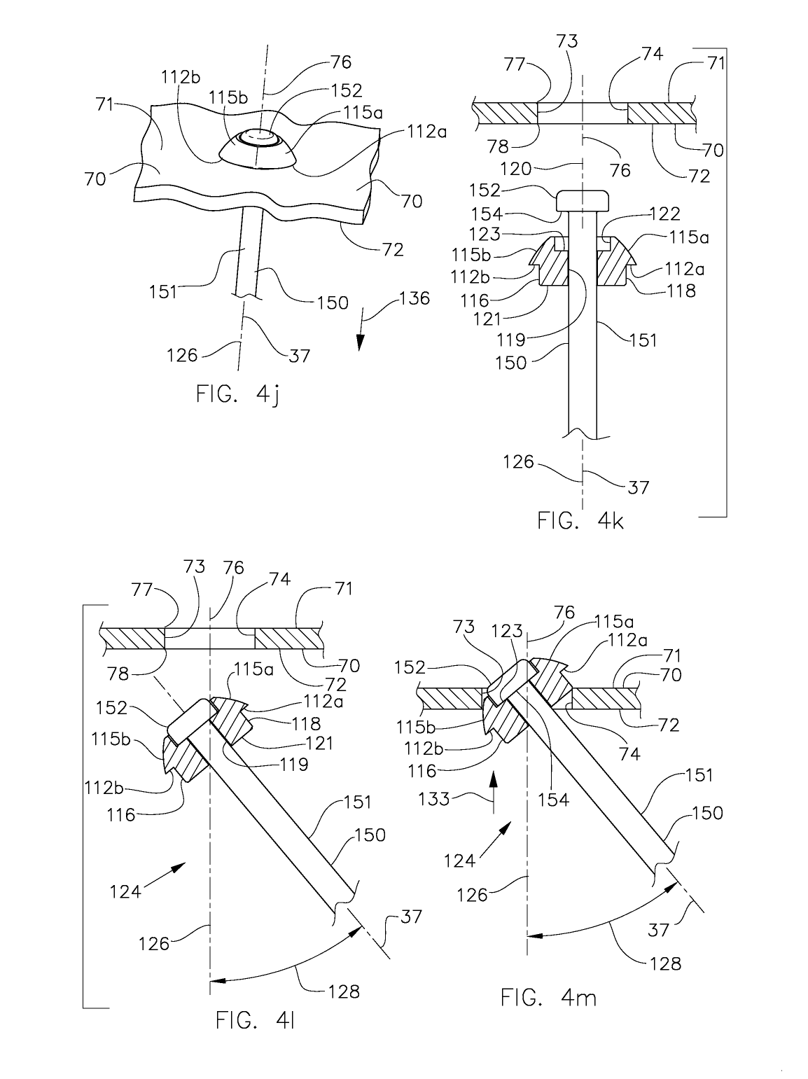

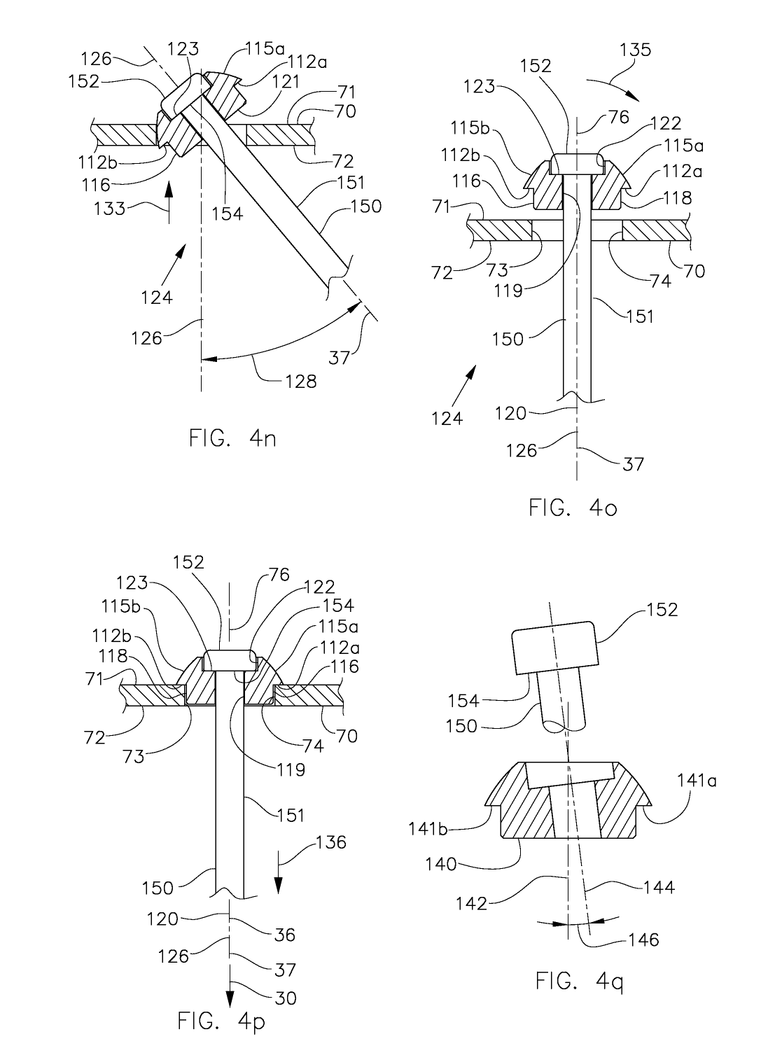

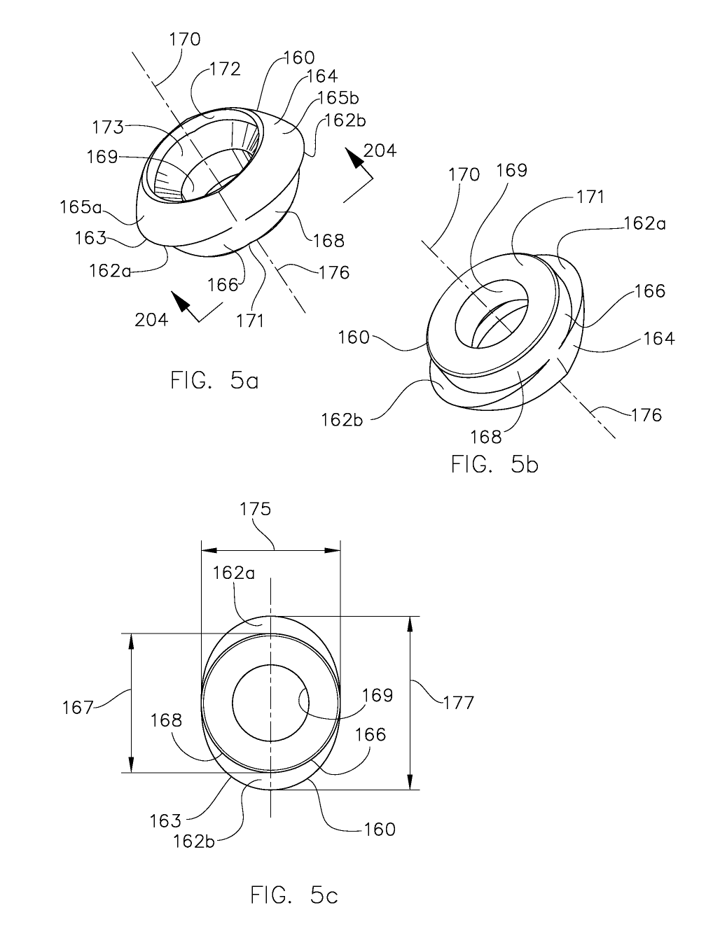

FIGS. 4a-p describe an embodiment of the present invention where a connector 110 is used to create a blind connection between a spoke 150 and a spoke bed 70. Connector 110 is shown to includes an outboard surface 114 with cheeks 115a and 115b, overhang surfaces 112a and 112b, and a central opening 119. Connector 110 also includes circular collar 116 with generally cylindrical sidewall 118 of diameter 117 that extends along an engagement axis 126 that is generally parallel to sidewall 118. Overhang surfaces 112a and 112b are shown to straddle the collar 116. Engagement axis 126 and cylindrical sidewall 118 also extends in a direction generally perpendicular to the overhang surfaces 112a and 112b. Sidewall 118 is shown with straight cylindrical geometry, however sidewall 118 may alternatively be tapered toward face 121 or may have a wide range of alternate geometries, such as relieved notches to provide clearance to facilitate the blind assembly of the connector 110 with the spoke bed 70. Central opening 119 is sized to accept shank portion 151 of spoke 150 and includes opening axis 120 and counterbore 122 that is sized to accept head 152, and includes step face 123 that is contoured to mate and engage with transition surface 154. The perimeter 113 of outboard surface 114 has a length 127 that is greater than its width 125. The width 125 is sized to correspond to the diameter 75 such that it may fit through hole 73, while the length 127 is greater than the diameter 75 of hole 73. It is noted that, since it is preferable that the diameter 117 of collar 116 be matched to the diameter 74 of the hole 73 as described herein, it is also preferable that the diameter 117 be approximately equal to the width 125 of the outboard surface 114. Since light weight of the connector 110 is a desirable attribute, it is preferable that the connector 110 be formed from a lightweight metal, such as aluminum, or else a reinforced polymer, such as a fiber reinforced engineering thermoplastic. However, a wide range of alternate materials may be utilized to produce the connector 110.

Spoke bed 70 is shown in FIGS. 4f-p in fragmentary view for illustration purposes. It is understood that spoke bed 70 constitutes a portion of the rim or hub flange (i.e. bracing element) to which the connector 110 is attached. The spoke bed 70 includes a radially outboard surface 71 and a radially inboard surface 72. Spoke bed 70 also includes a circular hole 73 therethrough with a hole sidewall 74 and a circular diameter 75 and an outboard edge 77 and an inboard edge 78. Hole 73 extends along central axis 76, which is shown here to be generally radial in direction. Spoke 150 includes a shank portion 151 with a longitudinal axis 37, an enlarged head 152, and a transition surface 154 therebetween. The spoke 150 is a generally long slender tensile element with a longitudinal axis 37 along its length. The spoke 150 also has a tensile axis 36 of applied tensile load, which is generally collinear to the longitudinal axis 37. For the purposes of definition, the term “longitudinal” herein refers to alignment along the longitudinal axis 37.

The spoke 150 is shown in FIG. 4f to be loosely preassembled to the connector 110, with the shank portion 151 extending through opening 119. It is preferable that the opening 119 is a close fit with the shank portion 151, as this will insure that the alignment of the connector 110 will closely follow the alignment of the spoke 150. The preassembly 124 is shown prior to assembly with the spoke bed 70 and aligned such that the opening axis 120 is generally collinear with the central axis 76 and is generally parallel with the longitudinal axis 37. Next, as shown in FIG. 4g, the preassembly 124 is tilted and skewed such that opening axis 120 has a tilt angle or toggle angle 128 relative to the central axis 76 and overhang surface 112a is radially outboard of overhang surface 112b. This may be considered as the “insertion orientation” of the connector 110 relative to the spoke bed 76.

Next, the preassembly 124 is inserted through hole 73 in an insertion direction 133, while maintaining the tilted insertion orientation, as shown in FIG. 4h. It is noted that connector 110 and spoke 150 are aligned relative to hole 73 such that overhang surface 112a enters hole 73 prior to overhang surface 112b. This permits insertion orientation the connector 110 to fit through the hole 73 as shown. As the connector 110 is advanced through hole 73 in the insertion direction 133, the toggle angle 128 may also be adjusted accordingly to allow the connector 110 to pass through hole 73. Next, once the connector 110 has advanced through the hole 73, the preassembly 124 is tilted again to reduce the toggle angle 128 such that opening axis 120 is aligned to be parallel to the central axis 76 and overhang surfaces 112a and 112b are aligned to be generally perpendicular to the central axis 76 as shown in FIG. 4i. This may be considered as the “engagement orientation” of the connector 110 relative to the spoke bed 76. Since the opening 119 has a close fit with the shank portion 151, the angular alignment between the connector 110 and the spoke 150 is maintained through the range between insertion and engagement orientations. As such, the spoke 150 may serve as a handle or an aid to control and maneuver the connector 110 as it is inserted through the hole 73 and as it is transitioned to the engagement orientation and engaged to the spoke bed 70.

Finally, as shown in FIG. 4j, spoke tension 30 is applied to spoke 150, drawing the spoke 150 in direction 136 such that the head 152 is nested in the counterbore 122 and transition surface 154 is engaged to the step face 123, thus also moving the connector in direction 136 such that the collar 116 is piloted and located within the hole 73 and overhang surfaces 112a and 112b are overlying and braced against the outboard surface 71 with an overlie engagement straddling the hole 73. The connector 110 is engaged to the spoke bed 70 to limit movement of the connector 110 in direction 136, which is generally opposed to the insertion direction 133. A firm connection between the spoke 150 and the spoke bed 70 is thus created to support spoke tension 30. It is noted that, while in the insertion orientation, the preassembly 124 may fit through hole 73 in insertion direction 133. However, when subsequently re-oriented to the engagement orientation, the connector 110 cannot fit back through the hole 73 in direction 136 due to the overlie engagement between the connector 110 and the spoke bed 70. In the engagement orientation, at least a portion of the projected perimeter 113 of the overhang surfaces 112a and 112b extends outside and beyond the diameter 75 of hole 73 as shown, thus overlapping and creating the overlie engagement between the connector 110 and the spoke bed 70. It is noted that the preassembly 124 has thus been blindly assembled and connected to the spoke bed 70. As defined herein, and also in industry, a blind assembly is one that has been achieved by installation with access to only one side of a part, in this case the blind assembly has required access only to the inboard surface 72 of the spoke bed 70.

FIGS. 4k-p are shown in cross section and describe the sequence of FIGS. 4f-j in greater detail. FIG. 4k corresponds to FIG. 4f. FIG. 4L corresponds to the assembly sequence of FIG. 4g. FIG. 4m corresponds to the assembly sequence of FIG. 4h and FIG. 4n corresponds to the transition between the assembly sequence of FIG. 4h and the assembly sequence of FIG. 4i, where the connector 110 is shown to be further advanced in its insertion through hole 73. FIG. 4o corresponds to the assembly sequence of FIG. 4i and FIG. 4p corresponds to the assembly sequence of FIG. 4j and shows head 152 nested within counterbore 122, with transition surface 154 overlying and engaged to step face 123, and with the collar 116 extending within hole 73 to overlap and locate against sidewall 74, and with overhang surfaces 112a and 112b overlying and bearing against outboard surface 71.

The connector 110 is generally shown to serve as a termination to the spoke 150 and provide means to connect or anchor the spoke 150 to a bracing element (i.e. rim and/or hub shell). Note that the span of spoke 150 is aligned in the direction of spoke tension 30 and along the tensile axis 36, which extends to be collinear with the longitudinal axis 37 of the spoke 150. It is understood that several spokes 150 of the wheel may be terminated in this manner. For simplicity in describing many of these embodiments, a spoke-to-rim connection arrangement is described, with the understanding that such an embodiment may be easily adapted to spoke-to-hub connections as well.

It is noted that the diameter 117 of collar 116 may be sized to have a close fit within the hole 73 to provide a close locating engagement between the connector 110 and the spoke bed 70. Since the spoke 150 also may have close locating engagement within opening 119, the spoke 150 may have close alignment relative to the spoke bed 70 to limit excessive axial and/or tangential movement of the spoke 150 therebetween. Thus, the connector 110 may be utilized to centralize the spoke 150 within the hole 73. It is also noted that geometry of connector 110, shown in FIGS. 4a-p, is schematic and additional geometric features may be included in the connector 110 to further enhance its blind engagement function and/or its interaction with the spoke bed 70 and/or its interaction with the spoke 150.

It is noted that in the arrangement of FIGS. 4i-j and 4o-p, the opening axis 120 of the connector 110 is generally collinear to the engagement axis 126 and to the central axis 76 and overhang surfaces 112a and 112b are generally perpendicular to the opening axis 120. It is understood that the opening axis 120 may alternatively be at an incline angle relative to the central axis 76. It is also understood that overhang surfaces 112a and 112b may alternatively be at an incline angle relative to the opening axis 120 and/or the central axis 76. It is further understood that the opening axis 120 may alternatively be parallel and offset (i.e. non-collinear) with the engagement axis 126. Additionally, it is also noted that the cylindrical collar 116 extends along an engagement axis 126 that is perpendicular to overhang surfaces 112a and 112b. Alternatively, the cylindrical collar may extend along an axis that is at an incline angle relative to overhang surface 112a and/or overhang surface 112b. Such an incline angle would be beneficial if, for example, the hole 62 were drilled at a non-perpendicular angle to the outboard surface 59 of the spoke bed 70. Such alternate arrangement(s) may be incorporated with many of the embodiments of the present invention.

An exemplary alternate arrangement is schematically illustrated in FIG. 4q, which shows a connector 140, including overhang surfaces 141a and 141b, that is similar to connector 110, with the exception that the opening axis 142 is at a non-parallel incline angle 146 relative to the engagement axis 144. In such an arrangement, the spoke 150 and connector 140 may be assembled to the spoke bed 70 as previously described. However, with the connector 140 fully seated in the spoke bed 70, as described in FIGS. 4j and 4p, the spoke may be aligned at an angle 146 (relative to the central axis 76) that may be aligned with the bracing angle of the spoke 150 or with any other desired angle of the spoke 150 and/or longitudinal axis 37. Since, in most bicycle wheel applications, the bracing angle is usually somewhere between 4 degrees and 12 degrees, it may be preferable that the incline angle 146 be set at an angle within the range of 4 degrees to 12 degrees. Such an incline angle 146 may also be utilized to accommodate a non-radial or oblique angle associated with crossed-spoke lacing, a common arrangement in bicycle wheels where the spokes emanating from a hub flange will be aligned to cross over each other, as illustrated in FIG. 2a.

The embodiment of FIGS. 4a-p show the overhang surfaces 112a and 112b to be generally flat and coplanar. It is envisioned that overhang surface 112a may be alternatively be offset and non-coplanar with overhang surface 112b. It is further envisioned that overhang surface 112a may be alternatively be inclined relative to overhang surface 112b. It is further envisioned that overhang surfaces 112a and/or 112b may incorporate a wide range of alternate non-flat geometries, including curved, notched, conical, spherical, etc. Such alternate arrangement(s) may be incorporated with many of the embodiments of the present invention.

The present invention comprises a spoke, which may be considered as a longitudinal tensile element having an end portion and a cross-section thereof, a connecting element, a bracing element, and a tensile axis of applied tensile load along the longitudinal tensile element. The spoke 100 is connected to the connecting element by means of an overlie connection between the spoke, or between an intermediate element connected to the spoke, and the connecting element. In the embodiments shown herein, the longitudinal tensile element is a vehicle wheel spoke, the hub shell or hub flange constitutes a first bracing element and the outer rim constitutes a second bracing element.

As described herein, a spoke is a generally long slender longitudinal tensile element, with a length greater than its cross sectional thickness, and with a longitudinal axis extending generally along its length. The spoke includes external sidewall surface(s) that extend generally along its length. As such, the longitudinal axis is generally parallel to the sidewall surface. The tensile axis is the axis along which tensile loads are applied to the tensile element, and is commonly collinear with the longitudinal axis, particularly in the region of the structural span of the longitudinal tensile element. For the purposes of explanation herein, the term “longitudinal axis” is generally interchangeable with the term “tensile axis”, unless otherwise noted. Some examples of a longitudinal tensile element include the spoke of a vehicle wheel, a guy wire, a control cable, or a tendon. In most of the embodiments of the present invention, the longitudinal tensile element is capable of supporting tension, otherwise known as positive tensile loading, along its length. However, the tensile element may alternatively support compression, otherwise known as negative tensile loading, along its length, where the longitudinal tensile element provides columnar support between two bracing elements. The spoke span is considered as the portion of the spoke that is under tension and that extends between its anchor points and/or engagements at the bracing elements (i.e. hub and rim). A location outboard of the spoke span is a location along the tensile axis that is beyond or external to the spoke span. Further, a longitudinally outward orientation refers to an orientation along the longitudinal axis that is distal from the midpoint of the span. Conversely, a longitudinally inward orientation is refers to an orientation along the longitudinal axis that is proximal to the midpoint of the span. In reference to the spoke, a lateral orientation or direction is an orientation or direction that is generally perpendicular to the longitudinal axis.

As described herein, a bracing element is one that resists or braces against all or part of the load of a tensile element. In other words, in order for a tensile element to maintain its tension (or compression) and remain a generally static structure, it must have a resisting or bracing element to bear against. Thus, the tensile element is generally anchored to two bracing elements and the tensile element thereby serves to connect the two bracing elements to each other. In an example where the tensile element is generally held in tension, such as the spoke of a tension-spoke vehicle wheel, a first bracing element could be the hub flange and a second bracing element could be the outer rim hoop. Similarly, in the case where the tensile element is generally held in compression, such as the spoke of a compression-spoke vehicle wheel, the bracing element is that element which the tensile element is pushed against.

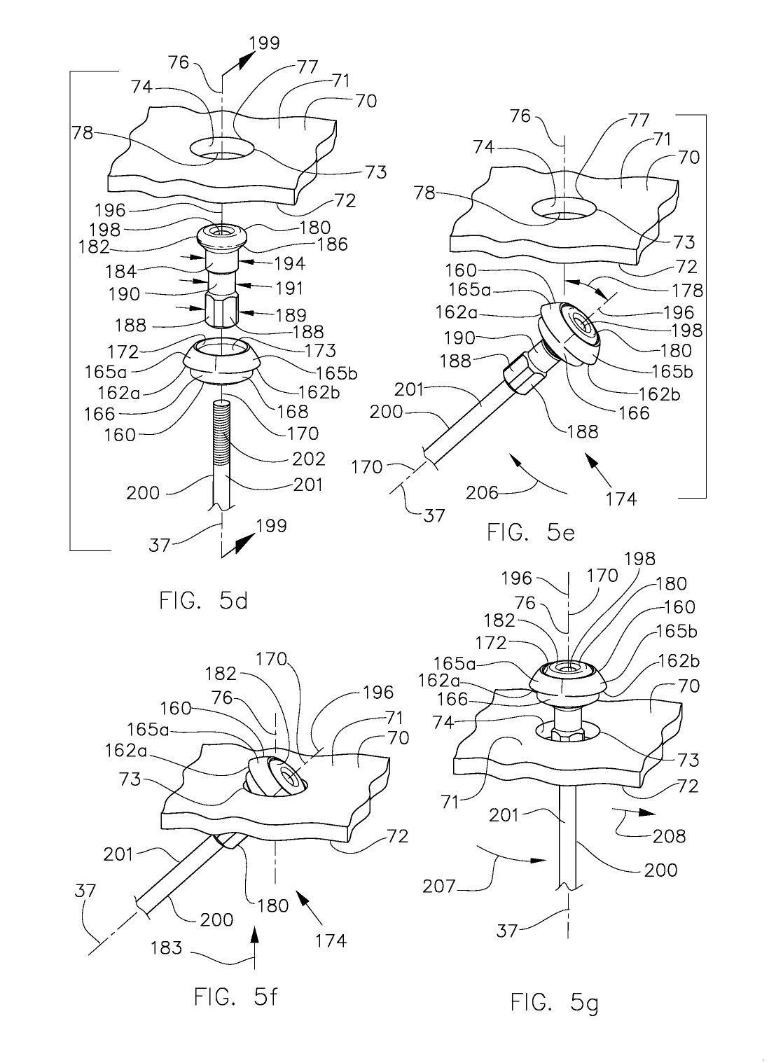

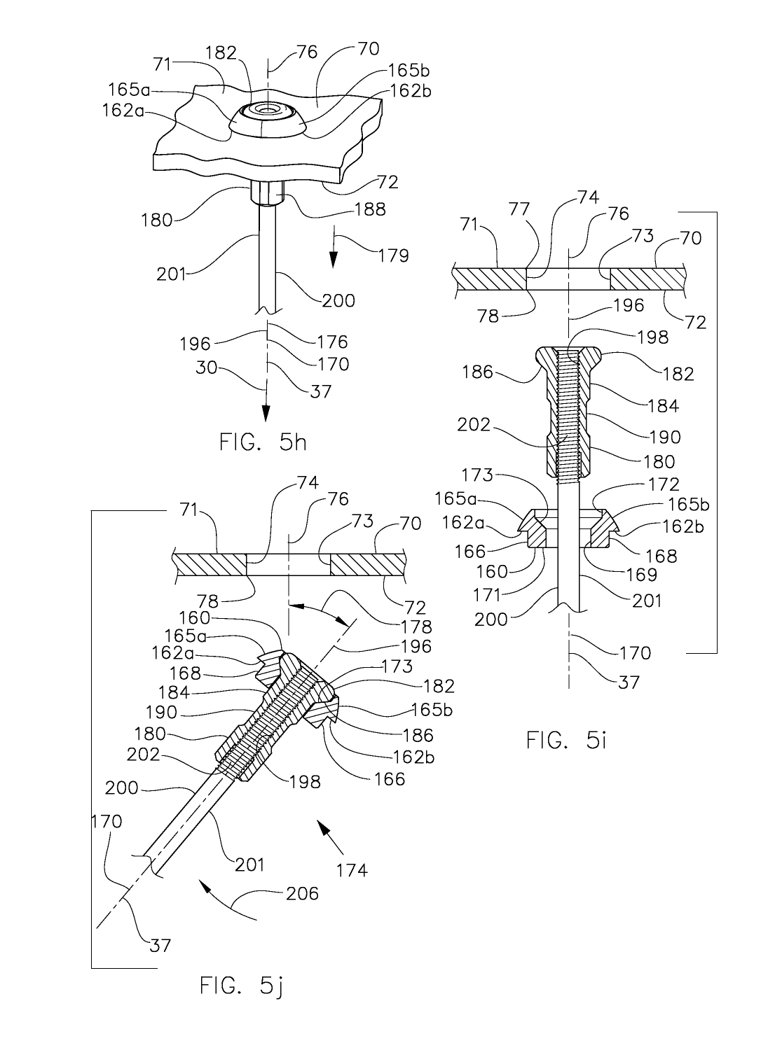

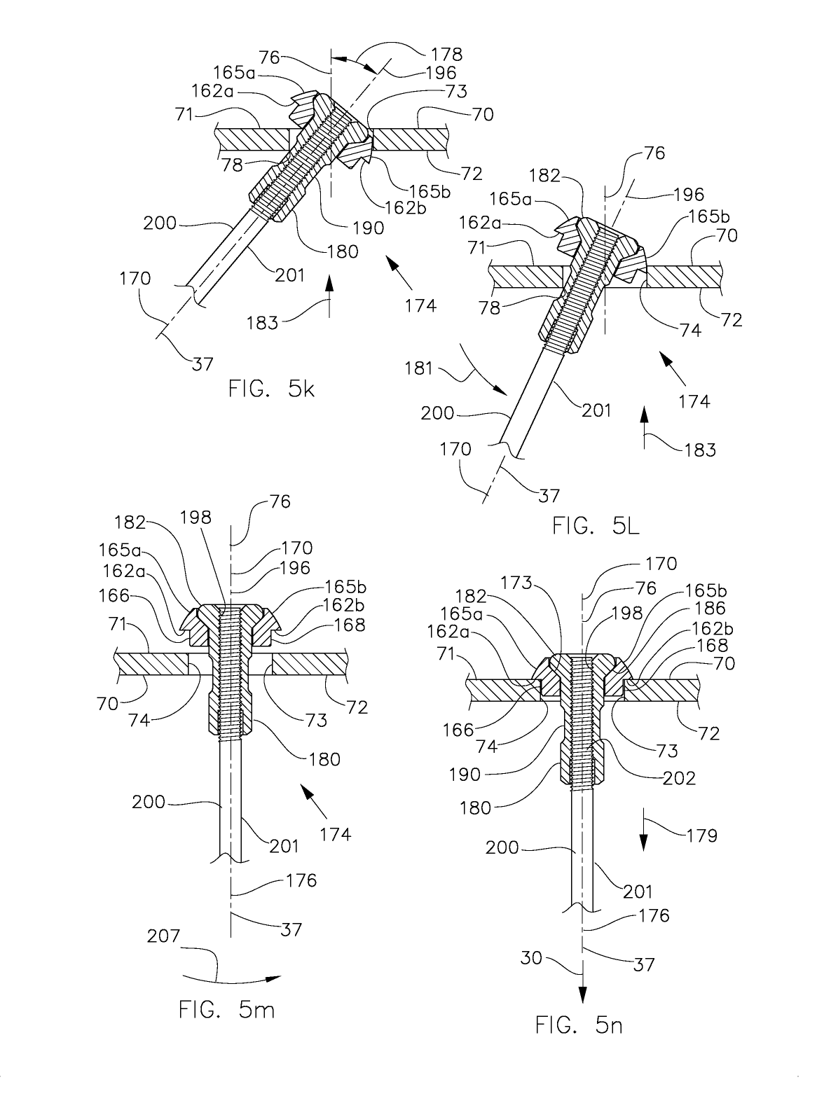

FIGS. 5a-n describe an embodiment illustrating a blind connection between the spoke and the spoke bed that is almost identical to that of FIGS. 4a-p, with the exception that a spoke nipple 180 is incorporated into the assembly to serve as an intermediate connecting element between the spoke 200 and the connector 160.

As shown in FIGS. 5a-c, connector 160 is shown to include an outboard surface 164 with cheeks 165a and 165b, overhang surfaces 162a and 162b, and a central opening 169. Connector 160 also includes a circular collar 166 with an engagement axis 176 and with generally cylindrical sidewall 168 of diameter 167 that extends between overhang surfaces 162a and 162b and end face 171. Overhang surfaces 162a and 162b are shown to straddle the collar 166. Sidewall 168 is shown with straight cylindrical geometry, however sidewall 168 may alternatively be tapered toward face 171 or may have a wide range of alternate geometries. Central opening 169 is sized to accept shank portion 184 of nipple 180 and includes an opening axis 170 and a counterbore 172, which is sized to accept head 182, and includes step face 173 that is contoured to mate with transition surface 204. The projected perimeter 163 of outboard surface 164 has a length 177 that is greater than its width 175, as shown in FIG. 5c. The width 175 is sized to fit through hole 73, while the length 177 is greater than the diameter 75 of hole 73. It is noted that, since it is preferable that the diameter 177 of collar 166 be matched to the diameter 74 of the hole 73 as described herein, it is also preferable that the diameter 177 be approximately equal to the width 175 of the outboard surface 164. Since light weight of the connector 160 is a desirable attribute, it is preferable that the connector 160 be formed from a lightweight metal, such as aluminum, or else a reinforced polymer, such as a fiber reinforced engineering thermoplastic. However, a wide range of alternate materials may be utilized to produce the connector 160.

Spoke bed 70 is shown in FIGS. 5d-n to be in fragmentary view for illustration purposes and it is understood that spoke bed 70 constitutes a portion of the rim or hub flange (i.e. bracing element) to which the connector 160 is attached. The spoke bed 70 is identical to that described in FIGS. 4a-p. As shown in FIGS. 5d and 5i, spoke 200 includes a shank portion 201 with a longitudinal axis 37 and a threaded end 202 to threadably engage with the spoke nipple 180 in the conventional manner. Spoke nipple 180 includes an enlarged head 182, a shank portion 184 and a transition surface 186 therebetween. Spoke nipple 180 also includes flats 188 for manual manipulation by means of a wrench (not shown) and an internally threaded central hole 198 to threadably mate with the externally threaded end 202 of the spoke 200 in the conventional manner. Shank portion includes a necked region 190 of reduced cross sectional dimension 191 relative to the cross sectional dimension 194 of shank portion 184 and preferably relative to the cross sectional dimension 189 in the region of said flats 188.

The spoke 200 is shown in FIGS. 5d-n to be threadably preassembled to the nipple 180 and also is loosely preassembled to the connector 160, with the shank portion 184 extending through opening 169 to create preassembly 174. It is preferable that the opening 169 is a close piloted fit with the shank portion 184, as this will insure that the alignment of the connector 110 will closely follow the alignment of the spoke 200. This preassembly 174 is shown in FIG. 5d prior to assembly with the spoke bed 70 and aligned such that the opening axis 170 is generally collinear with the central axis 76 and is generally parallel with the longitudinal axis 37. Next, as shown in FIG. 5e, the preassembly 174 is tilted and skewed in direction 206 such that opening axis 170 has a toggle angle 178 relative to the central axis 76 and overhang surface 162a is leading and outboard of overhang surface 162b along direction 173. This tilted orientation may be considered as the “insertion orientation” of the connector 160 relative to the spoke bed 76.

Next, the preassembly 174, while still in the insertion orientation, is inserted through hole 73 in insertion direction 183 as shown in FIG. 5f. It is noted that connector 160 is aligned relative to hole 73 such that overhang surface 162a enters hole 73 prior to overhang surface 162b. This insertion orientation permits the connector 160 to fit through the hole 73 as shown. As the connector 160 is advanced through hole 73, the toggle angle 178 may also be adjusted accordingly to maneuver the connector 160 to pass through hole 73. Next, once the connector 160 is advanced through the hole 73, the preassembly 174 is tilted in direction 207, and also shifted slightly in direction 208, such that engagement axis 176 is aligned to be collinear to the central axis 76 and overhang surfaces 162a and 162b are aligned to be generally parallel to the outboard surface 71 as shown in FIG. 5g. This may be considered as the “engagement orientation” of the connector 160 relative to the spoke bed 76. Since the opening 169 has a close fit with the shank portion 184, the angular alignment between the connector 160 and the spoke 200 is maintained through the range between insertion and engagement orientations. As such, the spoke 200 may serve as a handle to control and maneuver the connector 160 as it is inserted through the hole 73 and as it is transitioned to the engagement orientation and engaged to the spoke bed 70.

Finally, as shown in FIG. 5h, spoke tension 30 is applied to spoke 200, drawing the spoke 200 in direction 179 such that the head 182 is nested in the counterbore 172 and transition surface 186 is overlying and engaged to the step face 173, thus moving the connector 160 in direction 179 such that the collar 166 is piloted and located within the hole 73 and overhang surfaces 162a and 162b are overlying and braced against the outboard surface 71 of the spoke bed 70. Overhang surfaces 162a and 162b create two overlie engagements with the outboard surface 71 that are generally opposed about the central axis 76 and straddle the hole 73. A firm connection between the spoke 200 and the spoke bed 70 is thus created to support spoke tension 30. Further, the nipple 180 may be selectively rotated relative to the connector 160 and the spoke 200 about central axis 196 to adjust the threaded engagement between the externally threaded end 202 and the internally threaded hole 198, thereby adjusting spoke pretension in the conventional manner. It is noted that, while in the insertion orientation, the preassembly 174 may pass through hole 73 in insertion direction 183. However, when reoriented into the engagement orientation, the connector 160 cannot fit back through the hole 73 in direction 179 due to the overlie engagement between the connector 160 and the spoke bed 70. In the engagement orientation, at least a portion of the projected perimeter 163 of the overhang surfaces 162a and 162b extends outside and beyond the diameter 75 of hole 73 as shown, thus creating the overlie engagement between the connector 160 and the spoke bed 70. It is noted that the preassembly 174 has now been blindly assembled and connected to the spoke bed 70. If desired, the preassembly 174 and connector 160 may later be disassembled from the spoke bed 70 in the reverse sequence as described hereinabove.

FIGS. 5i-n are shown in cross section and describe the sequence of FIGS. 5d-h in greater detail. FIG. 5i corresponds to FIG. 5d. FIG. 5j corresponds to the assembly sequence of FIG. 5e. FIG. 5k corresponds to the assembly sequence of FIG. 5f and shows that necked region 190 serves as a relief to provide additional clearance between the shank portion 184 and the inboard edge 78 of hole 73, thus permitting the connector 160 and preassembly 174 to pass within hole 73. FIG. 5L corresponds to the transition between the assembly sequence of FIG. 5f and the assembly sequence of FIG. 5g, showing that, as the preassembly 174 is further advanced in insertion direction 183 through hole 73, it may also be maneuvered and tilted in direction 181 to allow the connector 160 to pass through hole 73. FIG. 5m corresponds to the assembly sequence of FIG. 5g and FIG. 5n corresponds to the assembly sequence of FIG. 5h.

It is noted that the nipple 180 may be regarded as an intermediate connecting element in the connection between the spoke 200 and the connector 160. In other words, the spoke 200 connects to the intermediate connecting element and the intermediate connecting element connects to the connector 160. There are a wide range of alternate intermediate connecting elements that may be utilized. As a further alternative, there may also be additional intermediate connecting elements inserted in this chain of connection.

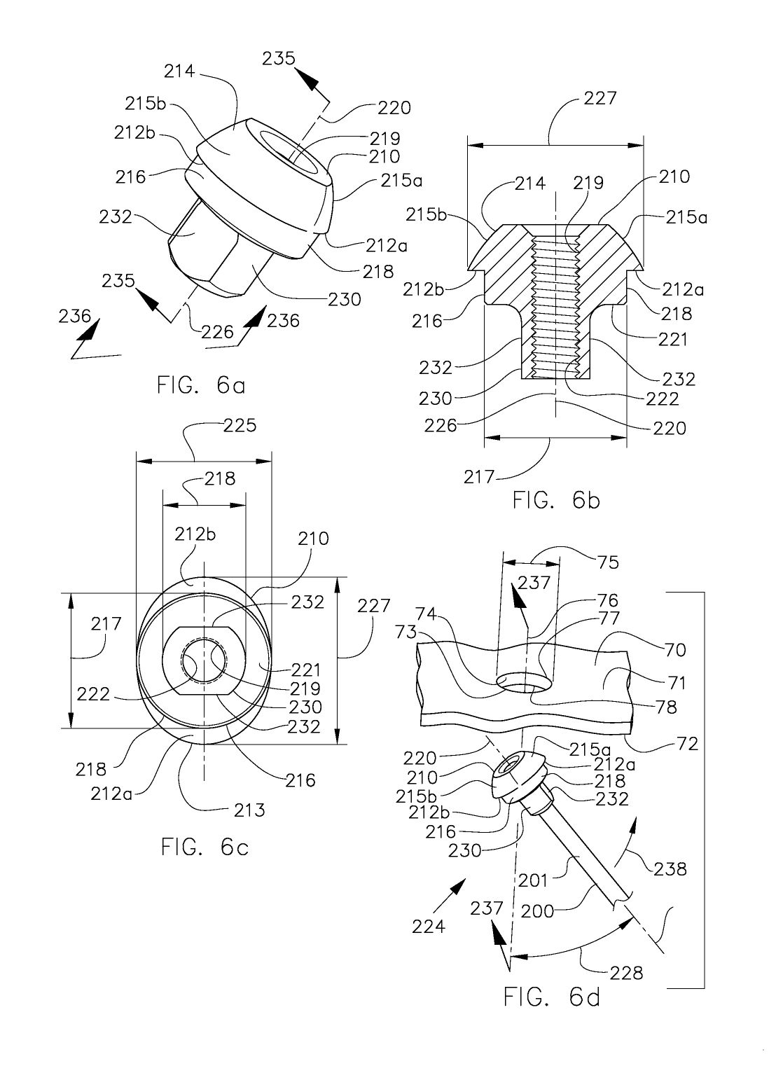

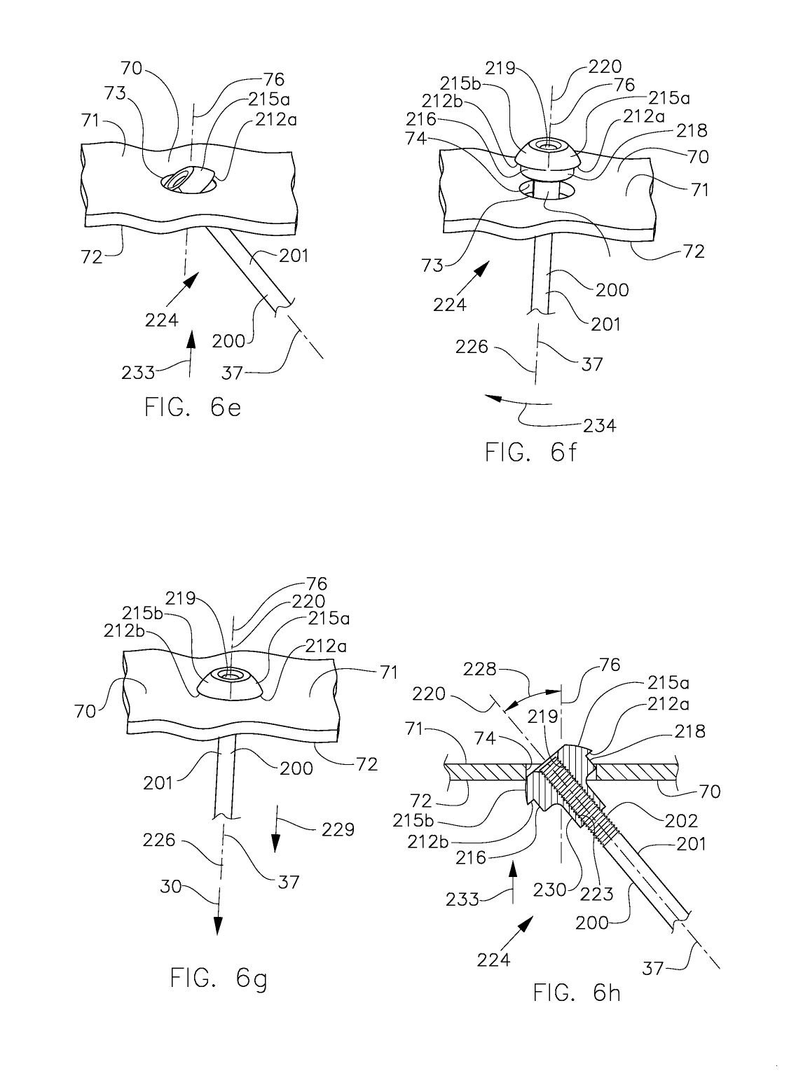

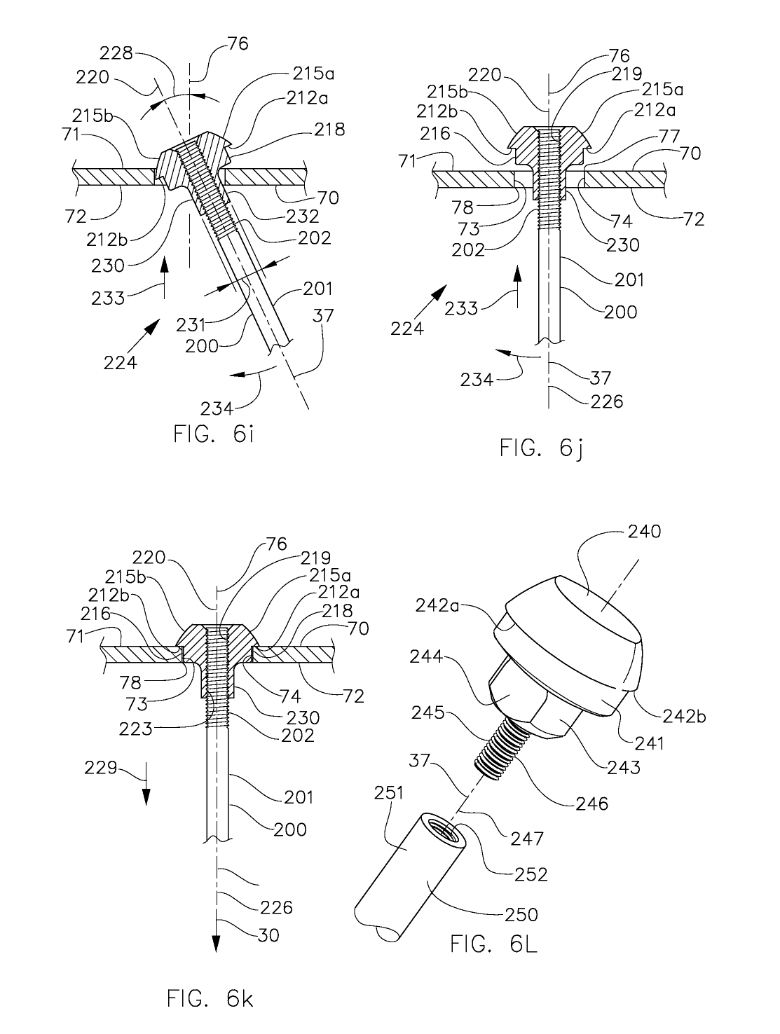

FIGS. 6a-k describe an embodiment illustrating a blind connection between the spoke and the spoke bed that is almost identical to that of FIGS. 5a-n, with the exception that a spoke nipple 180 is instead integrally incorporated into the connector 160 to create a one-piece connector 210. As shown in FIGS. 6a-c, connector 210 is shown to include an outboard surface 214 with cheeks 215a and 215b, overhang surfaces 212a and 212b, and a central opening 219. Connector 210 also includes circular collar 216 an engagement axis 226 and with generally cylindrical sidewall 218 of diameter 217 that extends between overhang surfaces 212a and 212b and end face 221. Overhang surfaces 212a and 212b are shown to straddle the collar 216. Sidewall 218 is shown with straight cylindrical geometry, however sidewall 218 may alternatively be tapered toward face 221 or may have a wide range of alternate geometries to provide clearance and/or to facilitate its insertion through hole 73. Connector 210 also includes an extension 230 that extends from face 221 and includes flats 232 to provide additional clearance during insertion within hole 73 and to engage with a wrench (not shown) for manual manipulation of the connector 210. The width 231 of extension 230 is preferably equal to or narrower than the diameter 217 of the collar 216 to provide the requisite clearance for insertion within hole 73 as described herein. The projected perimeter 213 of outboard surface 214 has a length 227 that is greater than width 125, with the width 125 sized to fit within the diameter 75 of hole 73, while the length 227 is greater than the diameter 75 of hole 73. It is noted that, since it is preferable that the diameter 217 of collar 216 be matched to the diameter 75 of the hole 73 as described herein, it is also preferable that the diameter 217 be approximately equal to the width 225 of the outboard surface 214. Central opening 219 includes opening axis 220 and consists of threaded hole 222 with internal threads 223. Since light weight of the connector 160 is a desirable attribute, it is preferable that the connector 210 be formed from a lightweight metal, such as aluminum or magnesium, or a reinforced polymer, such as a fiber reinforced engineering thermoplastic. However, a wide range of alternate materials may be utilized to produce the connector 210.

Spoke bed 70 is shown in fragmentary view for illustration purposes and it is understood that spoke bed 70 constitutes a portion of the rim or hub flange (i.e. bracing element) to which the connector 210 is attached. The spoke bed 70 is identical to that described in FIGS. 4a-q. Spoke 200 includes a shank portion 201 with a longitudinal axis 37 and a threaded end 202 to threadably engage with the threaded hole 222 in the conventional manner.

The spoke 200 is shown in FIGS. 6d-k to be threadably preassembled to the connector 210, with the threaded end 202 threadably engaged to threaded hole 222 to create preassembly 224. As shown in FIG. 6d, the preassembly 224 is tilted and skewed in direction 238 such that engagement axis 220 has a toggle angle 228 relative to the central axis 76 and overhang surface 212a is leading overhang surface 212b along central axis 76. This may be considered as the “insertion orientation” of the connector 210 relative to the spoke bed 76.

While still in its insertion orientation, the preassembly 224 is next inserted through hole 73 in insertion direction 233 as shown in FIG. 6e. It is noted that connector 210 is aligned relative to hole 73 such that overhang surface 212a enters hole 73 prior to overhang surface 212b. This permits the connector 210 to fit through the hole 73 as shown. As the connector 210 is advanced through hole 73, the toggle angle 228 may also be adjusted accordingly to maneuver the preassembly 224 and allow the connector 210 to pass through hole 73. Next, once the connector 210 is advanced through the hole 73, the preassembly 224 is tilted again, also shifting the preassembly 224 slightly tangentially, such that engagement axis 226 is aligned to be collinear to the central axis 76 and overhang surfaces 212a and 212b are aligned to be generally perpendicular to the central axis 76 as shown in FIG. 6f. This may be considered as the “engagement orientation” of the connector 210 relative to the spoke bed 76. Since the threaded end 202 has a threaded engagement with the threaded hole 222, the angular alignment between the connector 210 and the spoke 200 is maintained through the rage between insertion and engagement orientations. As such, the spoke 200 may serve as a handle to control and maneuver the connector 210 as it is inserted through the hole 73 and as it is transitioned to the engagement orientation and engaged to the spoke bed 70.

Finally, as shown in FIG. 6g, spoke tension 30 is applied to spoke 200, drawing the spoke 200 in direction 229 such that the collar 216 is piloted and located within the hole 73 and overhang surfaces 212a and 212b are overlying and braced against the outboard surface 71 of the spoke bed 70. Overhang surfaces 212a and 212b create two overlie engagements with the outboard surface 71 that are generally opposed about the central axis 76 and straddle the hole 73. A firm overly engagement connection between the spoke 200 and the spoke bed 70 is thus created to support spoke tension 30. Further, the connector 210 may be selectively rotated about engagement axis 226 relative to the spoke bed 70 and relative to the spoke 200 to adjust the threaded engagement between the externally threaded end 202 and the internally threaded hole 222, thereby functioning as a blindly assembled spoke nipple to adjust spoke pretension in the conventional manner. The overlie engagement between the overhang surfaces 212a and 212b and outboard surface 71 is maintained during this adjustment and the connector 210 is preferentially not rotationally keyed to the spoke bed 70 to permit this rotation. Alternatively, connector 210 may be rotationally keyed or otherwise fixed to the spoke bed 70, with the spoke 200 rotated about the opening axis 220 to adjust this threaded engagement. As a further alternative, the connector 210 may be rotationally fixed to both the spoke bed 70 and the spoke 200, with this threaded engagement thereby simply serving to provide a nonadjustable connection between the spoke 200 and the connector 210.

It is noted that, while in the insertion orientation, the preassembly 224 may fit through hole 73 in insertion direction 233. However, when reoriented into the engagement orientation, the connector 210 cannot fit back through the hole 73 in direction 229 due to the overlie engagement between the connector 210 and the spoke bed 70. In the engagement orientation, at least a portion of the projected perimeter of the overhang surfaces 212a and 212b extends outside and beyond the diameter 75 of hole 73 as shown, thus creating the overlie engagement between the connector 210 and the spoke bed 70. The collar 216 serves to engage the sidewall 74 of hole 73 and to align the connector to maintain the overlie engagement between overhang surfaces 212a and 212b and the outboard surface 71. Collar 216 also serves to center the opening 219 within the hole 73. It is noted that the preassembly 214 has thus been blindly assembled and connected to the spoke bed 70. Removal or disassembly of the connector 210 and preassembly 224 is simply the reverse of the installation sequence just described.

FIGS. 6h-k are shown in cross section and describe the sequence of FIGS. 6d-g in greater detail. FIG. 6h corresponds to FIG. 6e and shows that the reduced width 231 extension 230 and flats 232 provide additional clearance between the connector 210 and the inboard edge 78 of hole 73, thus permitting the connector 210 and preassembly 224 to pass within hole 73. FIG. 6i corresponds to the transition between the assembly sequence of FIG. 6e and the assembly sequence of FIG. 6f, showing that, as the preassembly 224 is further advanced in insertion direction 233 through hole 73, it may also be tilted in direction 234 to allow the connector 210 to pass through hole 73. FIG. 6j corresponds to the assembly sequence of FIG. 6f and FIG. 6k corresponds to the assembly sequence of FIG. 6g.

For general definition purposes herein, an “integral” joinder is one that is integrated at the mating joining interface between the two components or portions being joined. This integral joinder may not be easily disassembled at the service temperature without damaging at least one of the joined components or their mating joining interface surfaces. This integral joinder usually involves a mated joining interface directly between two components. This joining interface may include a welded or adhered interface or some other interface where the two mated joining surfaces are solidly stuck or joined to each other at a joining interface to create a unified structure. Preferably this joining interface is a surface interface, with a surface area, rather than a point or edge interface. The integral joinder is in contrast to a fastened joinder, where such a fastened joinder relies on a removable or semi-removable mechanical means to bind, secure or connect the two components to each other. In a fastened joinder, the two components may generally be separated without damaging joined components and/or their mating interface surfaces.

While FIGS. 6a-k show a threaded connection between threaded end 202 and threaded hole 222, other alternative connection means are possible. For example, threaded hole 222 may alternatively be a smooth hole and threaded end 202 may alternatively be a smooth end, with the smooth end inserted in the smooth hole and with adhesive included in the interface therebetween. The adhesive would then serve to integrally join the spoke 200 to the connector 210. In a further alternative, the spoke 200 and the connector 210 may be formed as a single monolithic element. For example, the spoke may be formed of stainless steel rod that may be headed at its end in a heading process well known in industry. The geometry of the headed end may correspond to the external geometry of the connector 210, such that the headed end would serve the same function as connector 210.

FIG. 6L describes a connector 240 that is an alternative configuration of connector 210 where the internal threaded hole 222 is omitted in favor of an externally threaded stud 245. Thus, connector 240 includes collar 241 with an engagement axis 247 and overhang surfaces 242a and 242b and extension 243 with flats 244 that are similar to their corresponding features of connector 210. Connector 240 also includes an externally threaded stud 245 with external threads 246 to threadably mate with internal threads 252 of spoke 250. Connector 240 and spoke 250 may otherwise be installed within the hole 73 of spoke bed 70 as previously described in FIGS. 6a-k and may also function as previously described in FIGS. 6a-k.

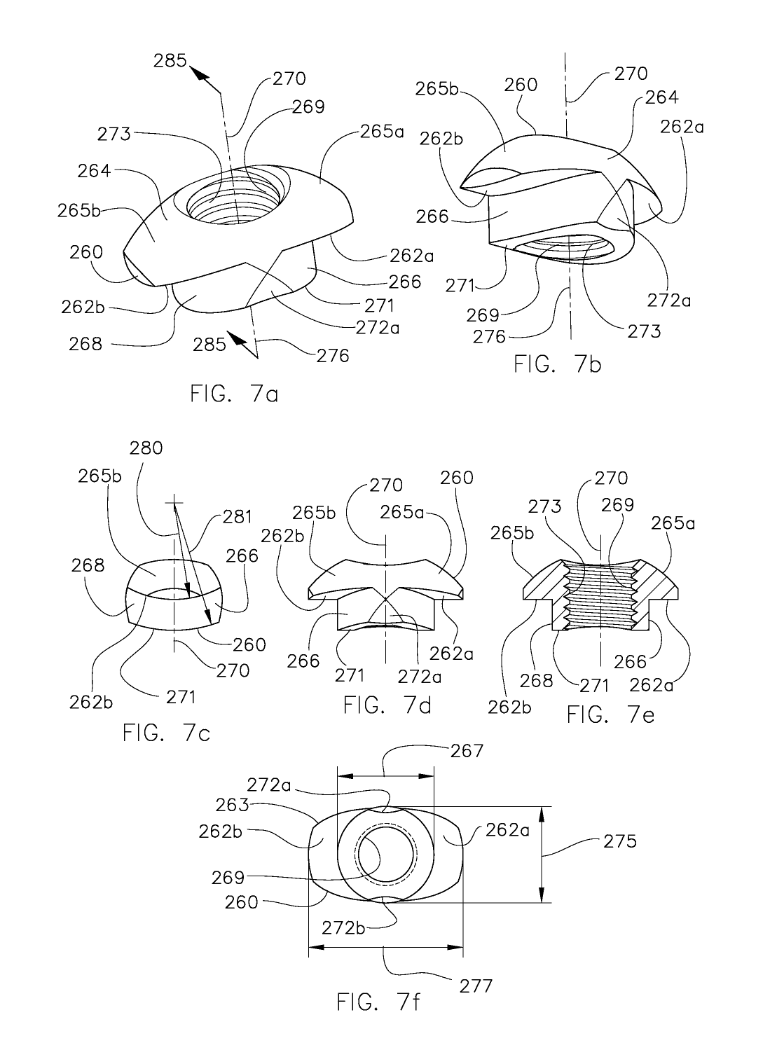

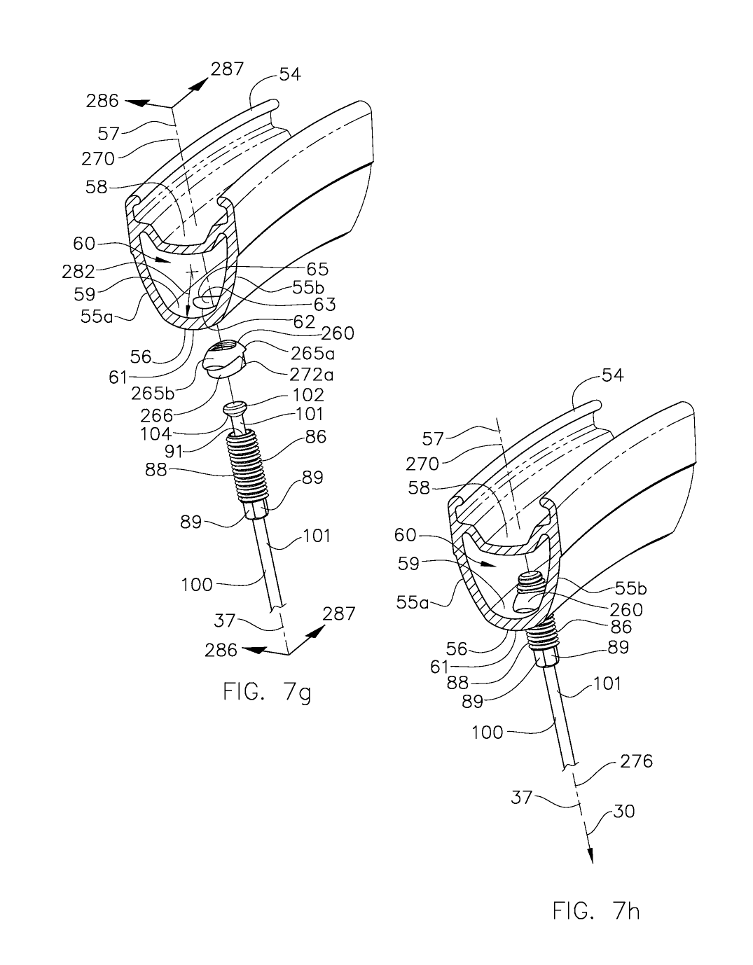

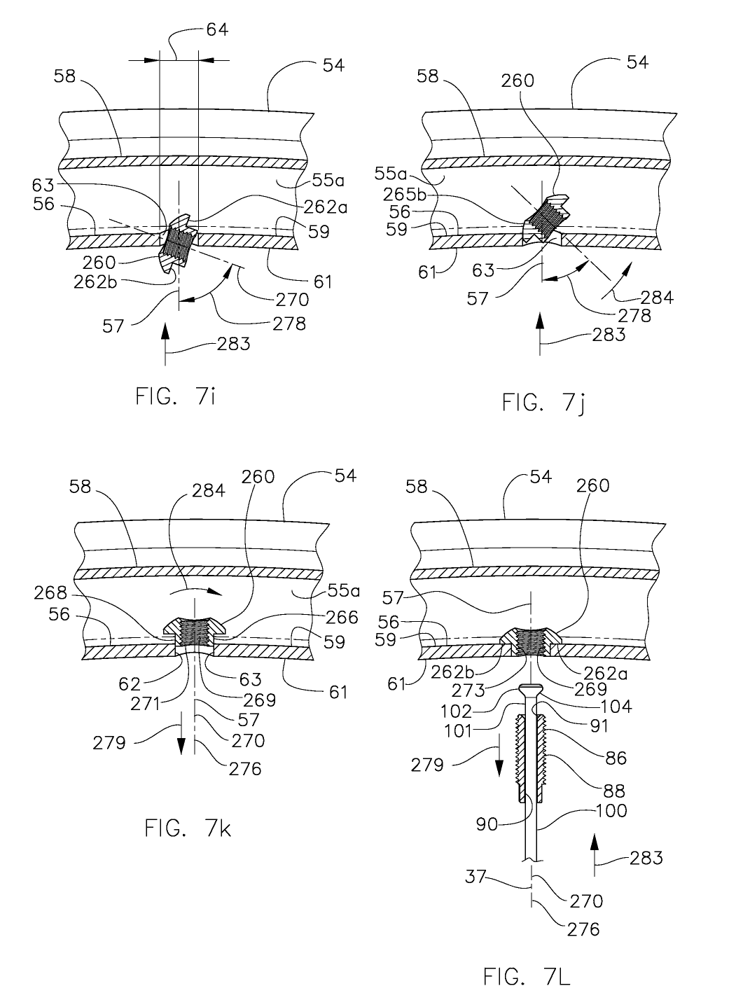

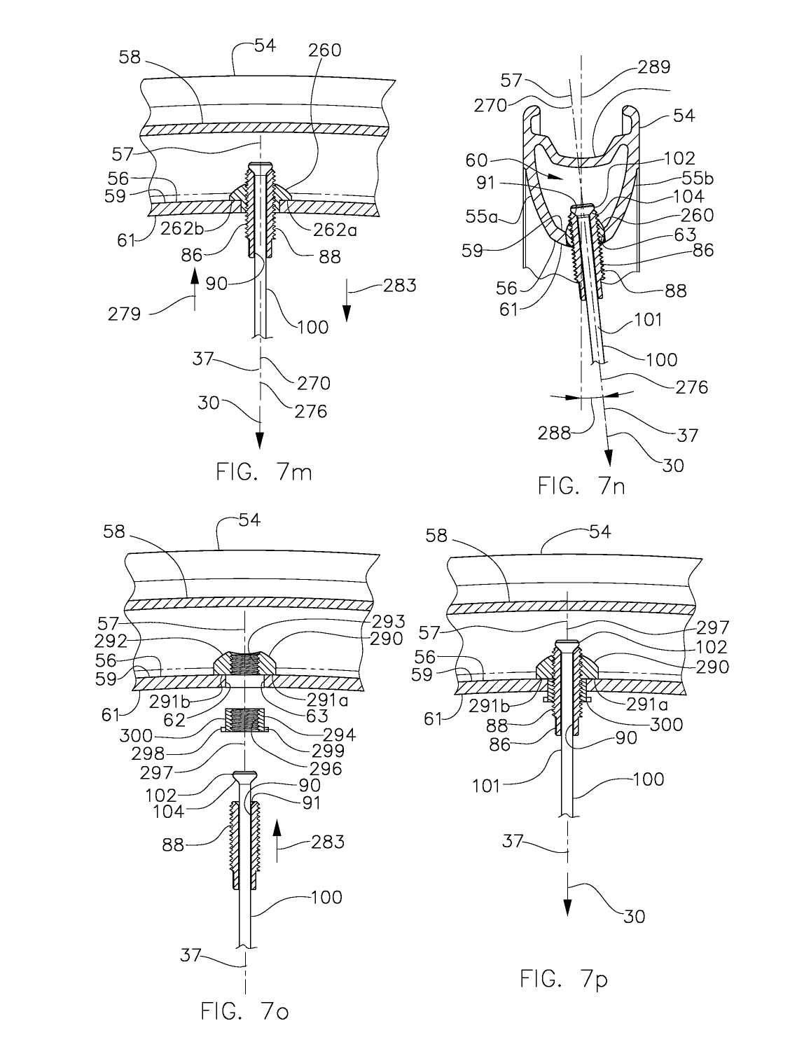

FIGS. 7a-n describes an embodiment illustrating a blind connection between the spoke and the spoke bed, with a connector similar to that of FIGS. 6a-k, however connector 260 does not include an extension. Also, instead of a direct threaded connection between the spoke 200 and the connector 210, an intermediate connecting element is incorporated into the assembly in the form of threaded sleeve 86.

As shown in FIGS. 7a-f connector 260 is shown to include an outboard surface 264 with cheeks 265a and 265b, overhang surfaces 262a and 262b, and a central opening 269. Connector 260 also includes circular collar 266 an engagement axis 276 and with generally cylindrical sidewall 268 of diameter 267 that extends between overhang surfaces 262a and 262b and end face 271. Collar 266 includes relieved notches 272a and 272b to provide clearance with the outboard edge 65 and hole sidewall 63 during insertion of the connector 260 within hole 62. Sidewall 268 is shown with straight cylindrical geometry, however sidewall 268 may alternatively be tapered toward face 271 or may have a wide range of alternate geometries to provide clearance and/or to facilitate its insertion through hole 62. The projected perimeter 263 of outboard surface 264 has a length 277 that is greater than its width 275. The width 275 is sized to fit through hole 63, while the length 277 is greater than the diameter 64 of hole 63. It is noted that, since it is preferable that the diameter 267 of collar 266 be matched to the diameter 64 of the hole 63 as described herein, it is also preferable that the diameter 267 be approximately equal to the width 275 of the outboard surface 264. It is noted that overhang surfaces 262a and 262b are curved surfaces with radius 280 and end face 271 is a curved surface with radius 281, as particularly illustrated in FIG. 7c. Central opening 269 extends along opening axis 270 and includes internal threads 273. Since light weight of the connector 260 is a desirable attribute, it is preferable that the connector 260 be formed from a lightweight metal, such as aluminum or magnesium, or a reinforced polymer, such as a fiber reinforced engineering thermoplastic. However, a wide range of alternate materials may be utilized to produce the connector 260.

Rim 54, as shown in FIGS. 7g-p includes a tire bed 58 wall, sidewalls 55a and 55b, and a spoke bed 56 wall with a cavity 60 or radial gap therebetween. The tire bed 58 supports the tire (not shown) and the spoke bed 56 includes a radially outboard surface 59 and a radially inboard surface 61. Spoke bed 56 is a curved wall with radius 282, as viewed in an axial plane and as particularly illustrated in the cross section profile of FIGS. 7g-h and both inboard surface 61 and outboard surface 59 are correspondingly curved as well. Spoke bed 56 also includes a hole 62 therethrough with hole sidewall 63 and circular diameter 64 and an outboard edge 65 at the intersection between hole 62 and outboard surface 59. Hole 62 extends along central axis 57, which is shown here to be generally radial in direction. Spoke 100 includes a shank portion 101 with a longitudinal axis 37, an enlarged head 102 and a conical transition surface 104 between shank portion 101 and head 102. Sleeve 86 includes external threads 88, a longitudinal hole 90 therethrough, and a countersink 91 to nest with transition surface 104. Sleeve also includes flats 89 such that it may be manually manipulated with a wrench (not shown). The spoke 100 is shown in FIG. 7g to be loosely preassembled to the sleeve 86, with the shank portion 101 extending through the hole 90 along the longitudinal axis 37.

FIG. 7g describes the spoke 100, sleeve 86, connector 260 and rim 54 in exploded view, with the connector 260 in the engagement orientation prior to assembly with the rim 54 and with the spoke 100 and sleeve 86 prior to connecting to the connector 260. The spoke 100 is shown to be loosely assembled to the sleeve, with shank portion 101 extending through hole 90 and transition surface 104 positioned near to countersink 91. FIG. 7h corresponds to the sequence of FIGS. 7m-n and describes the final assembly, with the connector 260 connected to the rim 54 and with the sleeve 86 threadably assembled to the opening 269 and with the spoke 100 engaged to the connector 260.

FIGS. 7i-n are shown in cross section and sequentially describe the progressive steps of assembly of the connector 260 and the spoke 100 to the rim 54. As shown in FIG. 7i, the connector 260 is first tilted and skewed such that engagement axis 270 has a toggle angle 278 relative to the central axis 57 and overhang surface 262a is leading overhang surface 262b along direction 283. This may be considered as the “insertion orientation” of the connector 210 relative to the spoke bed 56. In this insertion orientation, the connector 260 may be inserted within the hole 62 as shown. Next, as shown in FIG. 7j, the connector 260 is further advanced through hole 62 in direction 283 and the toggle angle 278 is also reduced to permit the connector to pass through the hole 62. It is noted that, in this general orientation, notches 272 provide clearance with the outboard edge 65, allowing the connector 260 to pass through hole 62, particularly while also being tilted and toggled toward the engagement orientation. Next, as shown in FIG. 7k, the connector has been advanced beyond the outboard surface 59 and shifted slightly tangentially with the toggle angle 278 reduced such that the insertion axis 276 is collinear with the central axis 57. Overhang surfaces 262a and 262b are now aligned to be generally perpendicular to the central axis 57 as shown. This may be considered as the “engagement orientation” of the connector 210 relative to the spoke bed 76. The connector 260 is then moved in direction 279 such that the collar 266 partially enters the hole 62 and the sidewall 268 is piloted within the sidewall 63. Next, as shown in FIG. 7L, the connector 260 is further advanced in direction 279 until overhang surfaces 262a and 262b contact and abut the outboard surface 59. Thus, it may be seen that overhang surfaces 262a and 262b have an overlie engagement with outboard surface 59 and the collar 266 is centered and piloted within hole 62. Overhang surfaces 262a and 262b create two overlie engagements with the outboard surface 71 that are generally opposed about the central axis 76 and straddle the hole 73. Spoke 100 and sleeve 86 are shown in position prior to threadable assembly between external threads 88 and internal threads 273.

Finally, as shown in FIGS. 7m-n, sleeve 86 is threadably assembled to connector 260, with external threads 88 engaged to internal threads 273 as shown. Transition surface 104 is matched and abutting countersink 91 in an overlie engagement as shown. Spoke tension 30 may be applied to spoke 100, drawing the spoke 100 in direction 279 such that the collar 266 is fully engaged within the hole 62 and overhang surfaces 262a and 262b are braced against the outboard surface 58 of the spoke bed 56. A firm connection between the spoke 100 and the spoke bed 560 is thus created to support spoke tension 30. Further, the sleeve 86 may be selectively rotated about opening axis 270 relative to the connector 260, with the spoke 100 optionally swiveling within hole 90, to adjust the threaded engagement between the external threads 88 and internal threads 273 to pretension the spoke 100 and adjust spoke tension 30 in the conventional manner.

It is noted that, while in the insertion orientation, the connector 260 may fit through hole 62 in direction 283. However, when the connector 260 is toggled and reoriented into the engagement orientation, an overlie engagement between the connector 260 and the rim 54 is created and the connector 260 cannot fit back through the hole 62. In the engagement orientation, at least a portion of the projected perimeter 263 of the overhang surfaces 262a and 262b extends outside and beyond the diameter 64 of hole 73 as shown, thus creating the overlie engagement between the connector 210 and the spoke bed 70. The threaded engagement between external threads 88 and internal threads 273 may also be considered an overlie engagement. It is noted that the spoke 100 has thus been blindly assembled and connected to the spoke bed 70.

The sleeve 86 may be regarded as an intermediate connecting element in the connection between the spoke 100 and the connector 260. In other words, the spoke 100 connects to the intermediate connecting element and the intermediate connecting element connects to the connector 260. There are a wide range of alternate intermediate connecting elements that may be utilized.

As previously described, the longitudinal axis 37 of the spoke 100 is rarely oriented to be perfectly radial relative to the spoke bed 56. Instead, the longitudinal axis 37 may be skewed at an angle in the radial plane 96 and/or in the axial plane 97. This particularly illustrated in FIG. 7n where the longitudinal axis 37 of the spoke 100 has a bracing angle 288 relative to a radial axis 289. It is preferable that the opening axis 270 be generally collinear with the longitudinal axis 37. As shown in FIG. 7n, the central axis 57 of hole 62 is aligned to be collinear with the longitudinal axis 37 and preferably passes through the center of radii 280 and 281. Such a hole 62 orientation is commonly referred to as an “angled spoke hole”. Since the curved overhang surfaces 262a and 262b are matched and nested with the curved outboard surface 264, the connector 260 may be aligned at any bracing angle 288, depending on the location and orientation of hole 62. This permits the engagement axis 276 to remain collinear with the opening axis 270. This aligned design may be applied to an of the embodiments herein.

It is noted that the nested engagement between the convex curved overhang surfaces 262a and 262b and the convex curved outboard surface 59 provides an anti-rotation engagement between the connector 260 and the rim 54 about the engagement axis 276. Such an anti-rotation engagement is particularly desirable in this embodiment since rotation of the connector would impede adjustment of the threaded engagement between the sleeve 86 and the connector 260. Alternatively, other anti-rotation engagement geometry arrangements may be incorporated within the connector and/or rim to provide such an anti-rotation feature. For example, the sidewalls 55a and 55b of the rim 54 may be positioned to engage the connector 260 to prevent independent rotation of the connector. As a further alternative, the outboard surface 59 may include raised projection(s) that engage corresponding recesses of the connector 260. As a still further alternative, the hole 62 may be non-circular, including non-circular or keyed sidewall 63 that mate with corresponding non-circular geometry of the sidewall 218 of collar 216 for a rotationally keyed engagement.

FIGS. 7g-n show the connector 260 to be inserted and engaged to the rim 54 prior to the threadable assembly of the sleeve 86 and the connector 260. This is illustrative of an arrangement where the connector is inserted into the hole of the spoke bed without the spoke (and/or intermediate connecting element) previously pre-assembled to the connector. Alternatively, the sleeve 86 may instead be preassembled to the connector 260 prior to its insertion in a similar manner to that described in the embodiments of FIGS. 4a-p or FIGS. 5a-n or FIGS. 6a-k.

While FIGS. 7a-n describe a connector 260 with an integral collar 266, the collar may alternatively be formed as a separate component from the rest of the connector 260. As an example, FIGS. 7o-p describe an embodiment where the connector 290 does not include a collar portion. Instead, an internally threaded collar 300 component is incorporated into the assembly. A shown in FIG. 7o, connector 290 includes overhang surfaces 291a and 291b, internally threaded hole 293, and outboard surface 292 that are each identical to their corresponding features of connector 260 (as described in FIGS. 7a-n). However, connector 290 does not include a collar or an extension that locates the sidewall 63 of hole 62. Instead, collar 300 is utilized, which includes a cylindrical outer surface 294, an internally threaded opening 296 (with opening axis 297) to receive the sleeve 86, and a flange 298 portion, with notches 299 therein. Threaded opening 296 may be threadably assembled to the external threads 88 of the sleeve 86, and the sleeve may be manipulated by means of a wrench engaged with notches 299. Rim 54, sleeve 86, and spoke 100 are identical to that described in FIGS. 7g-n. As shown in FIG. 7p, sleeve 86 is threadably assembled to connector 290 as previously described in FIGS. 7a-n and collar 300 is also threadably assembled to connector 290 as shown, such that outer surface 294 is located within hole 62 and is piloted within the sidewall 63, thus serving to centrally align the sleeve 86 with the hole 62. Collar 300 may be threaded to bear against the connector 290 in a locknut-type arrangement thus locking the threadable adjustment between the connector 290 and the sleeve 86.

While my above description contains many specificities, these should not be construed as limitations on the scope of the invention, but rather as exemplifications of embodiments thereof. It is to be understood that the invention is not limited to the illustrations described and shown herein, which are deemed to be merely illustrative of the best modes of carrying out the invention, and which are susceptible of modification of form, size, and arrangement of parts and details of operation. For example:

The embodiments described herein show the longitudinal axis of the spoke to be generally parallel to the central axis of the hole of the spoke bed. It is understood that this parallelism is for descriptive purposes and that the connector may employ geometry that will permit the spoke to be at almost any angle relative to the central axis of the spoke bed. For example, the connector may employ an inboard groove that permits the spoke to be oriented at an angle relative to the engagement axis. This angle may be beneficially oriented to allow the longitudinal axis of the spoke to be aligned with the bracing angle of the spoke. As a further alternative, the spoke may be bent in a region external to the connector to allow the longitudinal axis of the spoke span to be at an angle with the central axis of the hole in the spoke bed.

The embodiments described herein show a connector with a collar that extends within the hole of the spoke bed. It is noted that this collar is employed as a convenience to insure that the spoke may remain centered within the hole. Alternatively, the collar geometry may be omitted and the connector may include alternative geometry that will interface with the spoke bed to provide centering between the spoke and the hole. As a further alternative, such centering between the spoke and the hole may not be desired and thus the collar may be omitted. Further, while both the hole and the collar are shown to be generally circular, the collar may be non-circular, such as triangular shaped such that its triangular corners engage the circular hole to provide centering. Still further, in the case where the hole in the spoke bed is non-circular, the collar may employ a corresponding perimeter profile to match this non-circular hole

While the embodiments described herein show a generally circular hole in the spoke bed, with generally flat inboard and outboard surfaces, it is alternatively envisioned that the hole may be non-circular and that the collar of the connector may have mating non-circular geometry that will provide a rotationally keyed engagement between the connector and the spoke bed.

While the embodiments described herein show a spoke bed with generally flat inboard and outboard surfaces, it is alternatively envisioned that the outboard surface of the spoke bed may be non-flat to employ a curved surface and/or to employ projections and/or recesses. In such a case, the inboard surface of the connector may include geometry that mates and/or is matched to this non-flat outboard surface. Such a mating and/or matched interface may provide a keyed engagement between the connector and the spoke bed to limit relative rotation between these two elements about the central axis. Further, such a mating and/or matched interface may provide enhanced surface-to-surface contact for improved stress distribution at this interface.

These embodiments show a blind connection with a blind hole of the spoke bed through which the connector is connected. However the present invention can prove to be advantageous to achieve such a blind connection even in arrangements where the hole itself is not a blind hole and there is access to the opposite end (i.e. outboard surface) of that hole.

While the embodiments show a surface-to-surface overlie engagement between the outboard surface of the spoke bed and the overhang surface(s) of the connector, it is also envisioned that this overlie engagement may include a surface-to-edge engagement, where inboard surface of the connector includes an overlie engagement with an outboard edge of the spoke bed.

The nipple 180 and the sleeve 86 may each be regarded as an intermediate connecting element in the connection between the spoke and the connector. In other words, the spoke connects to the intermediate connecting element and the intermediate connecting element connects to the connector. There are a wide range of alternate intermediate connecting elements that may be utilized, such as washers (for example). Further, there may also be additional intermediate connecting elements inserted in this chain of connection.

Accordingly, the scope of the invention should be determined not by the embodiments illustrated, but is instead intended to encompass all such modifications that are within its spirit and scope as defined by the claims.

What is claimed is:

1. A vehicle wheel, comprising:
a peripheral rim;
a central hub with a central axle and an outer flange;
a plurality of spokes extending between said rim and said hub with a first portion connected to said rim and a second portion opposed to said first portion and connected to said hub and a span portion extending between said rim and said hub, wherein said spoke is a generally slender element with a length greater than its width and longitudinal axis along its length and a tensile axis of applied tensile load along said span portion;
a bracing element including a hole therein with a central axis, a hole sidewall, and at least one of an engagement surface and an engagement edge adjacent said hole and longitudinally outward of said opening;
a connecting element including a spoke opening therein with an opening axis and an overhang surface;
wherein said spoke is connected to said connecting element at said spoke opening;
wherein said connecting element is connected to said bracing element at said hole;
wherein said bracing element comprises at least a portion of at least one of said rim and hub;
wherein said connecting element may be transitioned between (i) an insertion orientation with a first angle between said opening axis and said central axis and (ii) an engagement orientation with a second angle between said opening axis and said central axis, with a toggle angle between said first angle and said second angle;
wherein, in said insertion orientation, said connecting element may be inserted within said hole in an insertion direction;
wherein, in said engagement orientation, said connecting element is engaged to said bracing element by means of an overlie engagement between said overhang surface and said at least one of said engagement surface and said engagement edge to limit relative movement between said connecting element and said bracing element in a direction generally opposed to said insertion direction;
wherein said overlie engagement supports said tensile load;
wherein said longitudinal axis of said spoke maintains a generally constant angular alignment with respect to said opening axis of said connecting element in both said insertion orientation and said engagement orientation; and
wherein said hole is a generally circular hole.

2. A wheel according to claim 1, wherein said spoke is connected to said connecting element by means of a spoke overlie engagement between said spoke and said connecting element and wherein said spoke overlie engagement supports said tensile load.

3. A wheel according to claim 1, wherein said spoke is integrally joined to said connecting element and wherein said integral joinder supports said tensile load.

4. A wheel according to claim 1, wherein said spoke is monolithic with said connecting element and formed as a singular element.

5. A wheel according to claim 1, wherein said connecting element includes a collar, such that, in said engagement orientation, said collar extends within said hole to overlap said hole sidewall along said central axis.

6. A wheel according to claim 5, wherein said collar includes relieved geometry to provide clearance for insertion of said connecting element within said hole of said bracing element.

7. A wheel according to claim 1, wherein said connecting element includes two of said overhang surfaces corresponding to two of said overlie engagements with said bracing element and wherein said two of said overlie engagements are generally opposed about said central axis and generally straddle said hole.

8. A wheel according to claim 1, wherein said connecting element has a length and a width, wherein said length is greater than said circular diameter of said hole and said width is less than or equal to said circular diameter of said hole.

9. A wheel according to claim 1, wherein said bracing element is said rim, including a spoke bed wall, wherein said hole is in said spoke bed wall and wherein said rim includes an outboard wall radially outboard radially outboard and connected to said spoke bed wall, and a radial gap between said spoke bed wall and said outboard wall, with said radial gap located adjacent said hole, and wherein said hole is obscured by said outboard wall in the radially outboard direction.

10. A wheel according to claim 1, wherein said central axis and said opening axis are generally parallel.

11. A wheel according to claim 1, wherein said central axis and said opening axis are generally non-parallel, with an angle therebetween and wherein said angle is between 4 degrees and 12 degrees.

12. A wheel according to claim 1, including an intermediate connecting element, wherein said spoke is connected to said intermediate connecting element at a first connection and said intermediate connecting element is connected to said connecting element at a second connection.

13. A wheel according to claim 12, wherein said intermediate connecting element includes a necked region of reduced lateral cross section dimension to provide additional clearance between said intermediate connecting element and said bracing element in said insertion orientation during said insertion within said hole in said insertion direction.

14. A wheel according to claim 1, wherein said connecting element is engaged to said bracing element to limit rotation of said connecting element relative to said bracing element about said central axis.

15. A vehicle wheel, comprising:
a peripheral rim;
a central hub with a central axle and an outer flange;
a plurality of spokes extending between said rim and said hub with a first portion connected to said rim and a second portion opposed to said first portion and connected to said hub and a span portion extending between said rim and said hub, wherein said spoke is a generally slender element with a length greater than its width and longitudinal axis along its length and a tensile axis of applied tensile load along said span portion;
a bracing element including a hole therein with a central axis, a hole sidewall, and at least one of an engagement surface and an engagement edge adjacent said hole and longitudinally outward of said opening;
a connecting element including a spoke opening therein with an opening axis and an overhang surface;
wherein said spoke is connected to said connecting element at said spoke opening;
wherein said connecting element is connected to said bracing element at said hole;
wherein said bracing element comprises at least a portion of at least one of said rim and hub;
wherein said connecting element may be transitioned between (i) an insertion orientation with a first angle between said opening axis and said central axis and (ii) an engagement orientation with a second angle between said opening axis and said central axis, with a toggle angle between said first angle and said second angle;
wherein, in said insertion orientation, said connecting element may be inserted within said hole in an insertion direction;
wherein, in said engagement orientation, said connecting element is engaged to said bracing element by means of an overlie engagement between said overhang surface and said at least one of said engagement surface and said engagement edge to limit relative movement between said connecting element and said bracing element in a direction generally opposed to said insertion direction;
wherein said overlie engagement supports said tensile load;
wherein said longitudinal axis of said spoke maintains a generally constant angular alignment with respect to said opening axis of said connecting element in both said insertion orientation and said engagement orientation; and
wherein said spoke opening includes internal threads and said spoke includes external threads and wherein said connection between said spoke and said connecting element includes a threadable engagement between said internal threads and said external threads to support said tensile load.

16. A wheel according to claim 15, wherein said connecting element is engaged to said bracing element to limit rotation of said connecting element relative to said bracing element about said central axis.

17. A wheel according to claim 16, wherein said hole of said bracing element is a non-circular hole and wherein said connecting element includes geometry to engage the sidewall of said non-circular hole to limit rotation of said connecting element relative to said bracing element about said central axis.

18. A wheel according to claim 15, wherein said connecting element includes a collar, such that, in said engagement orientation, said collar extends within said hole to overlap said hole sidewall along said central axis.

19. A wheel according to claim 18, wherein said collar serves to maintain alignment between said spoke and said central axis.

20. A wheel according to claim 18, wherein said collar includes relieved geometry to provide clearance for insertion of said connecting element within said hole of said bracing element.

21. A wheel according to claim 15, wherein said connecting element includes two of said overhang surfaces corresponding to two of said overlie engagements with said bracing element and wherein said two of said overlie engagements are generally opposed about said central axis and generally straddle said hole.

22. A wheel according to claim 15, wherein said connecting element includes an outer surface longitudinally outward of said outboard surface and wherein said outer surface is contoured such that a region of said outer surface adjacent said spoke opening is longitudinally outward of a region of said outer surface adjacent said overhang surface.

23. A wheel according to claim 1, wherein said bracing element is said rim, including a spoke bed wall, wherein said hole is in said spoke bed wall and wherein said rim includes an outboard wall radially outboard radially outboard and connected to said spoke bed wall, and a radial gap between said spoke bed wall and said outboard wall, with said radial gap located adjacent said hole, and wherein said hole is obscured by said outboard wall in the radially outboard direction.

24. A wheel according to claim 15, including an intermediate connecting element, wherein said spoke is connected to said intermediate connecting element at a first connection and said intermediate connecting element is connected to said connecting element at a second connection.

25. A wheel according to claim 24, wherein said intermediate connecting element includes a non-circular portion to facilitate manual manipulation of said intermediate connecting element.

26. A wheel according to claim 15, wherein said connecting element may be selectively rotated about said central axis while maintaining said overlie engagement.

27. A wheel according to claim 26, wherein said connecting element includes a non-circular portion to facilitate manual manipulation of said connecting element.

28. A wheel according to claim 15, wherein said hole is a circular hole with a circular diameter and wherein said connecting element has a length and a width, wherein said length is greater than said circular diameter of said hole and said width is less than or equal to said circular diameter of said hole.

29. A wheel according to claim 15, wherein, in said engagement orientation, said central axis and said opening axis are generally parallel.

30. A wheel according to claim 15, wherein, in said engagement orientation, said central axis and said opening axis are generally non-parallel, with an angle therebetween.
